(19) United States
(12) Patent Application Publication
(10) Pub. No.: US 2006/0178495 A1
(43) Pub. Date: Aug. 10, 2006

(54) Integral resin-silane coating system

(76) Inventors: William J. van Ooij, Fairfield, OH (US); Karthik Suryanarayanan, Cincinnati, OH (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/045,118

(22) Filed: Jan. 31, 2005

(51) Int. Cl. C08G 77/60; C08F 8/00

(52) U.S. Cl. 528/38; 528/25; 528/26; 525/342; 525/446

(57) ABSTRACT

A coating composition containing a resin; a curing agent; a catalyst; and a hydrolyzed bis-amino silane provides excellent adhesion between the substrate and the coating.

### BACKGROUND OF THE INVENTION

1. Field of the Invention

The present invention relates to a corrosion-resistant integral resin-silane coating system, a method of preparing the coating system and the coatings obtained.

2. Discussion of the Background

Metals such as steel corrode when exposed to an ambient environment causing deterioration of the metal surface and thus deterioration in appearance and durability.

Protective organic coatings are used to protect metal surfaces from corrosion. However, due to poor adhesion, the coatings may delaminate causing corrosion of the underlying metal surface. Thus, the adhesion strength between the metal and the coating is one of the determining factors of the quality of an anti-corrosion coating.

Many organic coating systems used in the industry for corrosion protection of the metal conventionally apply a chromate, phosphate or silane pretreatment followed by an epoxy or polyurethane primer coating and a topcoat using for example alkyd resin. See for example U.S. Pat. No. 4,775,600; U.S. Pat. No. 4,889,775; U.S. Pat. No. 5,723,210; U.S. Pat. No. 5,514,483; and U.S. Pat. No. 5, 213,846. Such coating systems are disadvantageous because they require several coating steps and contain toxic compounds such as chromates which have toxic and carcinogenic Cr(VI) ions.

Therefore, due to economic, environmental and health considerations, there has been a demand for alternative coating systems which do not contain chromium ions, which do not require pretreatment processes and which provide excellent adhesion between the metal and the coating and therefore minimal delamination.

WO 01/20058 A1 discloses a pre-paint aqueous treatment agent for metals containing a resin such as an urethane resin, an epoxy resin or an acrylic resin; a non-hydrolyzed silane coupling agent; and dispersed solid particles with a mean particle size of 1.0 μm or less. The treatment agent is chromium free. However, in order to obtain optimal corrosion resistance and adhesion of the coating system, a chemical plating treatment or a phosphate formation treatment is required before applying the treatment agent.

Further, Jyongsik Jang et al disclose a combination of a silane coupling agent and an epoxide to prevent corrosion and increase adhesion of a protective coating (Jyongsik Jang et al, “Corrosion Protection of Epoxy-Coated Steel Using Different Silane Coupling Agents”, Journal of Applied Polymer Science, Vol. 71, 585-593 (1999)). However, the silane is not hydrolyzed and thus does not form a dense three-dimensional siloxane network which is penetrated by the resin. In addition, the protective coating of Jang et al is not a true direct-to-metal primer which is compatible with commercial topcoats. Even though the coatings are described as “primers”, they are in fact only applied at very low thicknesses of about 1 micron which correspond to pretreatment levels and not primer thicknesses.

### SUMMARY OF THE INVENTION

It is therefore an object of the present invention to provide a corrosion-resistant organic coating system.

It is another object of the present invention to provide a non-chromate corrosion-resistant coating system.

It is yet another object of the present invention to provide a corrosion-resistant organic coating system that does not require a pretreatment process.

Further, it is an object of the present invention to provide a corrosion-resistant organic coating system having excellent adhesion between the substrate and the coating and therefore minimal delamination.

These and other objects, either individually or collectively, have been satisfied by the discovery of a coating composition, comprising:

a resin;

a curing agent;

a catalyst; and

a hydrolyzed bis-amino silane.

In another embodiment, the present invention includes a method of making a coating composition, comprising:

mixing a resin, a curing agent, a catalyst, and a hydrolyzed bis-amino silane.

In yet another embodiment the present invention includes an article, coated with a cured composition of a resin, a curing agent, a catalyst, and a hydrolyzed bis-amino silane.

The present invention further includes a corrosion protected structure, comprising:

a coating which comprises a resin, a curing agent, a catalyst, and a hydrolyzed bis-amino silane in cured form.

In addition, the present invention includes a method of coating a substrate, comprising:

coating a substrate with a composition comprising a resin, a curing agent, a catalyst, and a hydrolyzed bis-amino silane, to obtain a coating; and

curing said coating.

### BRIEF DESCRIPTION OF DRAWINGS

FIG. 1 shows the set-up for Electrochemical Impedance Spectroscopy measurements.

FIG. 2 shows the curve of an Electrochemical Impedance Spectroscopy measurement.

FIG. 3 shows the curve of an Electrochemical Impedance Spectroscopy measurement.

FIG. 4 shows the curve of an Electrochemical Impedance Spectroscopy measurement.

FIG. 5 shows the curve of an Electrochemical Impedance Spectroscopy measurement.

FIG. 6 shows the results of a salt spray test.

FIG. 7 shows the results of a salt spray test.

FIG. 8 shows the results of a salt spray test.

FIG. 9 shows the results of a salt spray test.

FIG. 10 shows the results of a salt spray test.

FIG. 11 shows the IR spectrum of DGEBA epoxy resin.

FIG. 12 shows the IR spectrum of a standard primer according to the present invention.

FIG. 13 shows the IR spectrum of a cured coating composition of the present invention on metal.

FIG. 14 shows the IR spectrum of non-hydrolyzed bis-sulfur silane.

FIG. 15 shows the IR spectrum of a coating composition according to the present invention.

FIG. 16 shows the IR spectrum of a cured coating composition of the present invention on metal.

FIG. 17 shows the ¹H-NMR spectrum of a coating composition of the present invention.

FIG. 18 shows the ¹H-NMR spectrum of a coating composition of the present invention.

FIG. 19 shows the ¹H-NMR spectrum of a coating composition of the present invention.

FIG. 20 shows the EIS data for the coating according to the present invention.

FIGS. 21 and 22 show the EIS data for the coating according to the present invention.

FIG. 23 shows EIS data for the coating according to the present invention.

FIG. 24 shows the salt immersion results for the coating according to the present invention.

FIG. 25 shows the results of the salt immersion test for the coating according to the present invention.

FIG. 26 shows SEM results for the coating according to the present invention.

FIG. 27 shows EDX results for the coating according to the present invention.

FIG. 28 shows SEM results for the coating according to the present invention.

FIG. 29 shows EDX results for the coating according to the present invention.

FIG. 30 shows SEM results for the coating according to the present invention.

FIG. 31 shows EDX results for the coating according to the present invention.

FIG. 32 is a schematic drawing of a coating according to the present invention.

FIG. 33 shows the results of a salt spray test.

### DETAILED DESCRIPTION OF THE INVENTION

The coating system according to the present invention is an integral primer which comprises a mixture of a resin, a curing agent, a catalyst, a hydrolyzed bis-amino silane and optionally a hydrophobic silane such as a bis-silane.

In a preferred embodiment, the coating system according to the present invention is free of chromates and thus free of the toxic Cr (VI) ions. It is particularly preferred that the integral primer according to the present invention does not contain chromate pigments such as strontium chromate and barium chromate.

In another embodiment, the coating system of the present invention eliminates all pretreatments, such as for example phosphating and chromating and pretreatment with silanes. The coating system provides excellent adhesion between the substrate and the coating and therefore minimal delamination.

The resin used in the present invention is not particularly limited and may include polyurethanes (PU), (meth)acrylates, polyesters, epoxy resins, polysiloxanes and fluoropolymers, alone or in mixtures. A preferred resin is epoxy resin. A preferred mixture of resins is a mixture of at least one (meth)acrylate and at least one epoxy resin. A low molecular weight and low viscosity of the resin are preferred to ensure excellent dispersion and wetting properties of the coating composition. The molecular weight of the resin is preferably in the range of from about 200 to 100,000 g/mol, preferably from about 200 to 50,000 g/mol, more preferably from about 200 to 20,000 g/mol, even more preferably from about 200 to about 5,000 g/mol and most preferably from about 200 to about 600 g/mol. The viscosity of the resin at 25° C. can be 1 to 175000 centipoise, preferably 1 to 15000 centipoise, and most preferably 1 to 300 centipoise. The viscosity of the resin at 25° C. includes all values and subvalues therebetween, especially including 5, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 400, 500, 600, 700, 800, 900, 1000, 5000, 10000, 20000, 30000, 40000, 50000, 60000, 70000, 80000, 90000, 100000, 110000, 120000, 130000, 140000, 150000, 160000, and 170000 centipoise.

If the molecular weight is higher than 100,000 g/mol, wetting becomes a problem because the resin is difficult to dissolve and highly viscous. High viscosities of these resins (for many resins higher than about 250 centipoise at 25° C.) inhibit the flow properties. As a result, it becomes difficult to obtain coatings having a thickness of 20-25 μm. Thus, a preferred viscosity for the resin when used without dilution is not higher than about 250 centipoise at 25° C. At molecular weights when the resin becomes a solid, wetting is difficult because of high viscosity. However, in a preferred embodiment, in order to obtain films having a thickness of 20-25 μm, the resin is diluted in a solvent.

The resin may be used in an amount of from 1 to 85 parts, preferably 5-70 parts, and particularly preferably 10-50 parts by weight based on the total weight of the composition. The amount of resin includes all values and subvalues therebetween, especially including 5, 10, 15, 20, 25, 30, 35, 40, 45, 50, 55, 60, 65, 70, 75, and 80 parts by weight.

The epoxy resin is not particularly limited. A single epoxy resin as well as mixtures of epoxy resins may be used. The epoxy resin is preferably a bisphenol-A epoxy resin. More preferably, the end groups of the bisphenol-A epoxy resin are hydrolyzed. Suitable are bisphenol A epoxy resins of the following general formula having about 1-500 repeating units

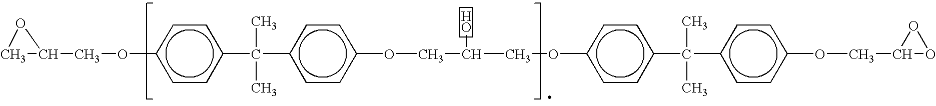

Further, non-bisphenol A epoxy resins can also be used, for example cycloaliphatic epoxy resins based on the formula

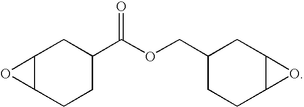

The epoxy resin may contain additional functional groups, such as hydroxyl, alkyl having 1 to 20 carbon atoms, or polymerizable groups such as vinyl groups.

The epoxy resin can be used in liquid and/or solid form, it can be water-reducible, water-borne or solvent-borne, with a curing agent incorporated or without a curing agent incorporated. Preferably, the epoxy resin is a liquid, solvent-borne, oven-cured epoxy resin.

The molecular weight of the epoxy resin may be in the range of from about 200 to 100,000 g/mol, preferably from about 200 to 50,000 g/mol, more preferably from about 200 to 20,000 g/mol, even more preferably from about 200 to about 5,000 g/mol and most preferably from about 200 to about 600 g/mol. The molecular weight of the epoxy resin includes all values and subvalues therebetween, especially including 300, 400, 500, 1000, 1500, 2000, 2500, 3000, 3500, 4000, 4500, 5000, 5500, 6000, 6500, 7000, 7500, 8000, 8500, 9000, 9500, 10000, 10500, 11000, 12000, 13000, 14000, 15000, 16000, 17000, 18000, 19000, 20000, 25000, 30000, 35000, 40000, 45000, 50000, 55000, 60000, 65000, 70000, 75000, 80000, 85000, 90000, and 95000 g/mol. A low molecular weight of the epoxy resin of from about 200 to about 600 g/mol is preferred for obtaining excellent dispersion properties of the silane in the coating system. Particularly preferred is an epoxy resin having a molecular weight of about 300 g/mol.

In one embodiment, diglycidyl ether of bisphenol A (DGEBA) may be used. The molecular weight of the DGEBA is not particularly limited. A preferred epoxide equivalent weight (g/eq.) is between 50-400 g/eq, more preferably 100 to 300 g/eq. The epoxide equivalent weight of DGEBA includes all values and subvalues therebetween, especially including 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380 and 390 g/eq. The DGEBA may be used in any form, for example, as solid flakes or as a viscous liquid. It is preferred to use a fluid DGEBA.

Further preferred is an epoxy resin which is obtained from Resolution Performance Products (www.resins.com): EPON 1009F having a molecular weight of 11,000 g/mol and a molecular weight per epoxide of 2300-3800 g/mol.

The polyurethane is not particularly limited. A single polyurethane as well as mixtures of polyurethanes may be used. Suitable commercially available polyurethanes include DEFTHANE, from Deft Chemical Coatings, Irvine, Calif., and DESOTHENE HS, from PRC DeSoto International Inc.

The polyurethanes may be substituted or unsubstituted. For example, the following partial structures of the main chain in which X₁ and X₂ are independently or simultaneously O or S, may be substituted or unsubstituted.

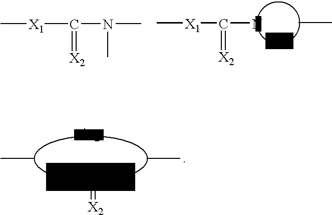

Suitable substituents are for example, polymerizable groups, such as vinyl groups, hydroxyl or alkyl groups having 1 to 20 carbon atoms

The molecular weight of the polyurethane may be in the range of from about 200 to 100,000 g/mol, preferably from about 200 to 50,000 g/mol, more preferably from about 200 to 20,000 g/mol, even more preferably from about 200 to about 5,000 g/mol and most preferably from about 200 to about 600 g/mol. The molecular weight of the polyurethane includes all values and subvalues therebetween, especially including 300, 400, 500, 1000, 1500, 2000, 2500, 3000, 3500, 4000, 4500, 5000, 5500, 6000, 6500, 7000, 7500, 8000, 8500, 9000, 9500, 10000, 10500, 11000, 12000, 13000, 14000, 15000, 16000, 17000, 18000, 19000, 20000, 25000, 30000, 35000, 40000, 45000, 50000, 55000, 60000, 65000, 70000, 75000, 80000, 85000, 90000, and 95000 g/mol. A low molecular weight, low viscosity polyurethane is preferred. The viscosity of the polyurethane at 25° C. can be about 1 to 2000 centipoise, preferably 1 to 1000 centipoise, and most preferably 1 to 300 centipoise. The viscosity of the polyurethane at 25° C. includes all values and subvalues therebetween, especially including 5, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 400, 500, 600, 700, 800, 900, 1000, 1100, 1200, 1300, 1400, 1500, 1600, 1700, 1800 and 1900 centipoise.

The (meth)acrylate is not particularly limited. The term “(meth)acrylate” includes methacrylates as well as acrylates which may be unsubstituted or substituted with at least one alkyl chain having 1 to 18 carbon atoms, or at least one hydroxyl group. Single (meth)acrylates as well as their mixtures may be used. The molecular weight of the (meth)acrylate may be in the range of from about 200 to 100,000 g/mol, preferably from about 200 to 50,000 g/mol, more preferably from about 200 to 20,000 g/mol, even more preferably from about 200 to about 5,000 g/mol and most preferably from about 200 to about 600 g/mol. The molecular weight of the (meth)acrylate includes all values and subvalues therebetween, especially including 300, 400, 500, 1000, 1500, 2000, 2500, 3000, 3500, 4000, 4500, 5000, 5500, 6000, 6500, 7000, 7500, 8000, 8500, 9000, 9500, 10000, 10500, 11000, 12000, 13000, 14000, 15000, 16000, 17000, 18000, 19000, 20000, 25000, 30000, 35000, 40000, 45000, 50000, 55000, 60000, 65000, 70000, 75000, 80000, 85000, 90000, and 95000 g/mol. A low molecular weight, low viscosity polyurethane is preferred. The viscosity of the (meth)acrylate at 25° C. can be 1 to 175000 centipoise, preferably 1 to 15000 centipoise, and most preferably 1 to 300 centipoise. The viscosity of the (meth)acrylate at 25° C. includes all values and subvalues therebetween, especially including 5, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 400, 500, 600, 700, 800, 900, 1000, 5000, 10000, 20000, 30000, 40000, 50000, 60000, 70000, 80000, 90000, 100000, 110000, 120000, 130000, 140000, 150000, 160000, and 170000 centipoise.

The polyesters used as resin in the present invention are not particularly limited as long as their viscosity is sufficiently low to allow good wetting properties and good dispersion properties. Polyesters, having the following structural units in the main chain, in which X₁ and X₂ are O or S, may be used

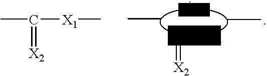

The polyesters may be unsubstituted or carry substituents. Suitable substituents may be alkyl groups having 1 to 20 carbon atoms, and hydroxyl groups.

Single polyesters as well as mixtures of polyesters may be used. The molecular weight of the polyester is in the range of from about 200 to 100,000 g/mol, preferably from about 200 to 50,000 g/mol, more preferably from about 200 to 20,000 g/mol, even more preferably from about 200 to about 5,000 g/mol and most preferably from about 200 to about 600 g/mol. Low molecular weight and low viscosity polyesters are preferred. The viscosity of the polyester at 25° C. can be 1 to 20000 centipoise, preferably 1 to 15000 centipoise, and most preferably 1 to 300 centipoise. The viscosity of the resin at 25° C. includes all values and subvalues therebetween, especially including 5, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 400, 500, 600, 700, 800, 900, 1000, 200, 3000, 4000, 5000, 6000, 7000, 8000, 9000, 10000, 11000, 12000, 13000, 14000, 15000, 16000, 17000, 18000 and 19000 centipoise.

The polysiloxanes used a resin are not particularly limited as long as their viscosity is sufficiently low to allow good wetting properties and good dispersion properties. The polysiloxanes may be substituted or unsubstituted. Suitable substitutents are for example, polymerizable groups such as vinyl groups; or alkyl groups having 1 to 20 carbon atoms, and hydroxyl groups.

Single polysiloxanes as well as mixtures of polysiloxanes may be used. The molecular weight of the polysiloxane is in the range of from about 200 to 100,000 g/mol, preferably from about 200 to 50,000 g/mol, more preferably from about 200 to 20,000 g/mol, even more preferably from about 200 to about 5,000 g/mol and most preferably from about 200 to about 600 g/mol. Low molecular weight and low viscosity polysiloxanes are preferred. The viscosity of the polysiloxane at 25° C. can be 1 to 20000 centipoise, preferably 1 to 15000 centipoise, and most preferably 1 to 300 centipoise. The viscosity of the polysiloxane at 25° C. includes all values and subvalues therebetween, especially including 5, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 400, 500, 600, 700, 800, 900, 1000, 200, 3000, 4000, 5000, 6000, 7000, 8000, 9000, 10000, 11000, 12000, 13000, 14000, 15000, 16000, 17000, 18000 and 19000 centipoise.

The fluoropolymers used a resin are not particularly limited as long as their viscosity is sufficiently low to allow good wetting properties and good dispersion properties. Preferred are fluoropolymers based on an ethylene polymer unit in which at least one hydrogen atom is substituted by a fluorine atom. The fluoropolymers may be substituted or unsubstituted. Suitable substitutents are for example, polymerizable groups such as vinyl groups. Single fluoropolymers as well as mixtures of fluoropolymers may be used. The molecular weight of the fluoropolymers is in the range of from about 200 to 100,000 g/mol, preferably from about 200 to 50,000 g/mol, more preferably from about 200 to 20,000 g/mol, even more preferably from about 200 to about 5,000 g/mol and most preferably from about 200 to about 600 g/mol. Low molecular weight and low viscosity fluoropolymers are preferred. The viscosity of the fluoropolymers at 25° C. can be 1 to 20000 centipoise, preferably 1 to 15000 centipoise, and most preferably 1 to 300 centipoise. The viscosity of the fluoropolymers at 25° C. includes all values and subvalues therebetween, especially including 5, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 400, 500, 600, 700, 800, 900, 1000, 200, 3000, 4000, 5000, 6000, 7000, 8000, 9000, 10000, 11000, 12000, 13000, 14000, 15000, 16000, 17000, 18000 and 19000 centipoise.

The curing agent used in the coating system of the present invention may be a polyisocyanate or a silane. Mixtures of at least one silane and at least one polyisocyanate may be used. The curing agent may be used in amounts of from 1 to 50 parts, preferably, 5 to 40 and most preferably 10 to 30 parts by weight based on the total weight of the coating composition. The amount of curing agent includes all values and subvalues therebetween, especially including 5, 10, 15, 20, 25, 30, 35, 40, and 45 parts by weight.

The polyisocyanate is not particularly limited. The term “polyisocyanate” refers to the presence of more than one isocyanate group. Preferred are aliphatic isocyanate prepolymers, aromatic prepolymers and their mixtures. An example of an alipathic isocyanate prepolymer is OCN—(CH₂)₆—N[CONH(CH₂)₆NCO]₂, derived from hexamethylene diisocyanate (HDI). An example of an aromatic isocyanate prepolymer is C₂H₅—C(CH₂0-CO—NH—C₇H₄NCO)₃, derived from toluene di-isocyanate (TDI).

The polyisocyanates may be used alone or in mixtures. Preferred are blocked polyisocyanates. For example, the polyisocyanate may be blocked with a diisocyanate, such as hexamethylene diisocyanate O═C═N—(CH₂)₆—N═C═O. Other suitable blocking agents are diphenylmethane diisocyanate, toluene diisocyanate, methylethylketoxime (MEKO), diethyl malonate (DEM) and 3,5-dimethylpyrazole (DMP). The polyisocyanates that are blocked with diisocyanates have to be heated to about 140° C. to break-open the diisocyanates and to expose the polyisocyanates which react with the resin, preferably the epoxy resin.

Further, the curing agent may be a commercially available curing agent, such as DESMODUR VP LS 2253 made by Bayer AG.

The silane curing agent is not particularly limited. For example, silanes represented by the following formulae may be used —Si(OX)₄, Y—Si—(OX)₃ wherein X and Y represent alkyl groups having 1 to 20 carbon atoms, such as methyl and ethyl.

A preferred silane curing agent is bis-amino silane: (H₃CO)₃Si(CH₂)₃NH(CH₂)₃Si(OCH₃)₃. The silane curing agent may be a commercially available silane from GE Silicones. Low temperature curing agents, preferably room temperature curing agents may be used as well. Room temperature curing is possible when using, for example, unblocked isocyanates, preferably aliphatic or aromatic, or imines.

The catalyst used in the coating system of the present invention is not particularly limited. Any catalyst that catalyzes the reaction between curing agent and resin is suitable, in particular metal organic catalysts. These catalysts include organic tin catalysts, salts of cobalt, such as cobalt neodecanoate, and salts of titanium, salts of zinc, salts of calcium, alone or in mixtures. Further, tin carboxylate, bismuth carboxylate, mercury carboxylate, zinc carboxylate, their mixtures and their mixtures with amines may be used as catalyst.

Organic tin catalysts are preferred. Preferred are organic tin salts represented by the formulae R₄Sn, R₃SnX, R₂SnX₂, and RSnX₃ in which R is an alkyl group having 1 to 20 carbon atoms or an aromatic group and X is an anion. Preferably, R is a butyl, octyl, or phenyl group and X is a chloride, fluoride, oxide, hydroxide, carboxylate, or thiloate. A particularly preferred tin catalyst is i-butyl tin dilaurate (DBTDL) having the formula C₃₂H₆₄O₄Sn. This tin catalyst is commercially available from Sigma-Aldrich Inc.

The catalyst may be used in an amount of from 0.001 to 5 parts, preferably 0.01 to 2 by weight, based on the total weight of the coating composition. The amount of catalyst includes all values and subvalues therebetween, especially including 0.005, 0.01, 0.05, 0.1, 0.5, 1, 1.5, 2, 2.5, 3, 3.5, 4, and 4.5 parts by weight.

The hydrolyzed bis-amino silane used in the coating system of the present invention is not particularly limited. The bis-amino silanes of the following formula may be used:
(R¹O)₃Si(R²)ₙNH(R³)ₙSi(OR⁴)₃

wherein

each R¹, R², R³, and R⁴, independently or simultaneously, may be a linear or branched alkyl radical or alkenyl radical having of from 1 to 18 carbon atoms, and

n is an integer of from 1 to 20.

R¹ and R⁴ are preferably, independently or simultaneously, methyl, ethyl, n-propyl, i-propyl, n-butyl, i-butyl or t-butyl. R² and R³ are preferably, independently or simultaneously, —CH₂— or —C₂H₄—.

Particularly preferred are bis-(trimethoxysilylpropyl)amine, (CH₃O)₃Si(CH₂)ₙNH(CH₂)ₙSi(OCH₃)₃, bis-[trimethoxysilylpropyl]ethylenediamine(bis diaminosilane), (CH₃O)₃—Si—(CH₂)₃—NH—(CH₂)₂—NH—(CH₂)₃—Si—(OCH₃)₃, and bis-triamino silane.

A preferred commercially available bis-amino-silane is A1170 from GE Silicones.

The above bis-amino silane is hydrolyzed in water or an alcohol such as methanol, ethanol, propanol or butanol and in mixtures of water with an alcohol. Other suitable solvents are dioxane, and acetone, alone or in mixtures with water. The water used in the process of the present invention is preferably deionized water (DI), more preferably deionized water having a resistivity of 18 MΩ·cm.

An acid such as acetic acid, formic acid, propionic acid, butanoic acid, or nitric acid may be added as catalyst for the hydrolyzing.

Bis-amino silane is hydrolyzed using about 75-99 vol. % of water, about 1-25 vol. % of ethanol, about 1-25 vol. % of silane, about 0.1-3 vol. % of an acid such as acetic acid, each based on the total amount of the solution prepared for the hydrolyzing. The pH of the solution is adjusted to about 6. Then the solution may rests for 1 minute to 4 hours. The resting time includes all values and subvalues therebetween, especially including 2, 3, 4, 5, 6, 7, 8, 9, 10, 15, 20, 25, 30, 35, 40, 45, 50, 55, 60, 90, 120, 150, 180, 210, 240, and 270 minutes.

Preferably, the hydrolyzation of bis-amino silane proceeds as follows. About 7 ml of water is added to about 86 ml of ethanol. A volume of bis-amino silane equal to the volume of water is added. The silane is added while the water-ethanol mixture is stirred using for example a magnetic stirrer. This step prevents the settling down of the bis-amino silane at the bottom of the reaction vessel and ensures proper mixing of the components. Then 2.5 ml of acetic acid is added to bring the pH of the solution to 6. This solution should rest for 2 hrs before use, preferably at room temperature.

The hydrolyzed bis-amino silane may be used in an amount of from 0.5 to 30, preferably 1 to 20, and particularly preferably 5 to 15 vol. % based on the total volume of the coating composition. The amount of hydrolyzed bis-amino silane includes all values and subvalues therebetween, especially including 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 18, 18.5, 19, 19.5, 20, 21, 22, 23, 24, 25, 26, 27, 28, and 29 vol. %.

The hydrophobic silane used in the coating system of the present invention is not particularly limited. Bis-silanes including bis-amino silane as described above, bis-sulfur silane, as well as mono-silanes can be used, alone or in mixtures. The hydrophobic silanes may be used directly or after hydrolysis in water or an alcohol such as methanol, ethanol, propanol or butanol and in mixtures of water with an alcohol. 0 to 25 vol. % of the hydrophobic silane may be used based on 100 vol. % of solution. The amount of hydrophobic silane in the solution includes all values and subvalues therebetween, especially including 0.5, 1, 1.5, 2, 2.5, 3, 3.5, 4, 4.5, 5, 5.5, 6, 6.5, 7, 7.5, 8, 8.5, 9, 9.5, 10, 12, 14, 16, 18, 20, 22 and 24 vol. %. A preferred mixture for hydrolysis is 5 vol. % of the hydrophobic silane, 5 vol. % of water and 90 vol. % of ethanol.

Bis-silanes of the following formula may be used:
(R¹O)₃Si(R²)ₙR′(R³)ₙSi(OR⁴)₃

wherein

R′ is a single bond, a linear or branched alkyl radical or alkenyl radical having of from 1 to 18 carbon atoms, —NH—, —S₂— or —S₄—,

each R¹, R², R³, and R⁴, independently or simultaneously, may be a linear or branched alkyl radical or alkenyl radical having of from 1 to 18 carbon atoms, and

one or two of R′, R² and R³ may be simultaneously a single bond,

n is an integer of from 1 to 20.

R¹ and R⁴ are preferably, independently or simultaneously, methyl, ethyl, n-propyl, i-propyl, n-butyl, i-butyl or t-butyl. R² and R⁴ are preferably, independently or simultaneously, —CH₂— or —C₂H₄—.

Further a bis-silane of the following formula may be used:
(R¹O)₃Si(R²)ₙSi(OR³)₃

wherein

each R¹, R², and R³, independently or simultaneously, may be a linear or branched alkyl radical or alkenyl radical having of from 1 to 18 carbon atoms,

R² may also be a substituted or unsubstituted aromatic ring, and

n is an integer of from 1 to 20.

R¹ and R³ are preferably, independently or simultaneously, methyl, ethyl, n-propyl, i-propyl, n-butyl, i-butyl or t-butyl. R² is preferably —CH₂—, —C₂H₄— or —C₆H₄—.

Particularly preferred is bis-(triethoxysilyl) ethane (BTSE), (C₂H₅O)₃Si(CH₂)₂Si(OC₂H₅)₃, and bis-(triethoxysilyl) benzene, (C₂H₅O)₃Si(C₆H₅)Si(OC₂H₅)₃.

In addition, bis-sulfur silanes of the following formula may be used:
(R¹O)₃Si(R²)ₙS₄(R³)ₙSi(OR⁴)₃

wherein

each R¹, R², R³, and R⁴, independently or simultaneously, may be a linear or branched alkyl radical or alkenyl radical having of from 1 to 18 carbon atoms, and

n is an integer of from 1 to 20.

R¹ and R⁴ are preferably, independently or simultaneously, methyl, ethyl, n-propyl, i-propyl, n-butyl, i-butyl or t-butyl. R² and R³ are preferably, independently or simultaneously, —CH₂— or —C₂H₄—.

Particularly preferred is bis-(triethoxysilylpropyl) tetrasulfane, (C₂H₅O)₃Si(CH₂)₃S₄(CH₂)₃Si(OC₂H₅)₃, which is sold as A1289 by GE Silicones.

In addition, bis-sulfur silanes of the following formula may be used:
(R¹O)₃Si(R²)ₙS₂(R³)ₙSi(OR⁴)₃

wherein

each R¹, R², R³, and R⁴, independently or simultaneously, may be a linear or branched alkyl radical or alkenyl radical having of from 1 to 18 carbon atoms, and

n is an integer of from 1 to 20.

R¹ and R⁴ are preferably, independently or simultaneously, methyl, ethyl, n-propyl, i-propyl, n-butyl, i-butyl or t-butyl. R² and R³ are preferably, independently or simultaneously, —CH₂— or —C₂H₄—.

Particularly preferred is bis-(triethoxysilylpropyl)disulfane, (C₂H₅O)₃Si(CH₂)₃S₂(CH₂)₃Si(OC₂H₅)₃, which is sold as A1589 by GE Silicones.

Other suitable bis-silanes include bis-[trimethoxysilylpropyl]urea, (CH₃O)₃—Si—(CH₂)₃—NH—CO—NH—(CH₂)₃—Si—(CH₃O)₃, bis(trimethylsilyl)acetylene, bis(aminopropyl)tetramethyldisiloxane, 1,3-bis(chloromethyldimethylsiloxy)benzene, bis(chloromethyl)methylchlorosilane, 1,1′-bis(dimethylsilyl)ferrocene, bis[(p-dimethylsilyl)phenyl]ether, and bis(methyldifluorosilyl)ethane.

Mono-silanes of the following formula may be used:
R¹(R²)ₙSi(OR³)₃

wherein

R¹ may be a vinyl group, a ureido group, a linear or branched alkyl radical or alkenyl radical having of from 1 to 18 carbon atoms,

Each of R² and R³, independently or simultaneously, may be a linear or branched alkyl radical or alkenyl radical having of from 1 to 18 carbon atoms, and

n is an integer of from 0 to 20.

R³ is preferably methyl, ethyl, n-propyl, i-propyl, n-butyl, i-butyl or t-butyl. R² is preferably —CH₂— or —C₂H₄—.

Particularly preferred are vinyltriethoxysilane, CH₂═CHSi(OC₂H₅)₃, and γ-ureidopropyltriethoxysilane, N₂HCN(O)H(CH₂)₃Si(OC₂H₅)₃.

The coating system of the present invention may contain a solvent or be solvent free. Suitable solvents are polar solvents. Preferred are n-butoxy-ethanol, methyl-ethyl-ketone (MEK), ethanol, acetone, dimethyl sulfide and dimethyl formamide. The solvent may be used in an amount of from 30 to 80% by vol. based on the volume of the coating composition. The amount of solvent includes all values and subvalues therebetween, especially including 35, 40, 45, 50, 55, 60, 65, 70, and 75 vol. %.

The coating system according to the present invention may further contain additional hydrophobic water-insoluble silanes or particles, alone or in combination.

The hydrophobic silanes may be non-hydrolyzed, partially hydrolyzed or fully hydrolyzed. Preferred are hydrolyzed hydrophobic silanes. The hydrophobic silanes are not particularly limited as long as they are at least substantially insoluble in water. Thus, any of the above described silanes which are substantially insoluble in water may be used. Preferred are bis-[triethoxy silyl propyl] disulfide, (C₂H₅O)₃—Si—C₃H₆—S₂—C₃H₆—Si (OC₂H₅)₃, available as A1589 from GE Silicones; bis-[triethoxysilyl] benzene, (C₂H₅O)₃—Si—C₆H₄—Si—(OC₂H₅)₃; and bis-[triethoxysilyl] alkanes of the general formula (C₂H₅O)₃—Si—CₙH₂ₙ—Si—(OC₂H₅), wherein n is 2-20, preferably n is 2, 6 or 8.

Particles include oxidic particles such as clay and silica, or non-oxidic particles such as carbon black. Particularly preferred particles are alumina and titania. The oxidic particles are used in amounts of from 1-10 wt. %. The amount of oxidic particles includes all values and subvalues therebetween, especially including 2, 3, 4, 5, 6, 7, 8, and 9 wt. %. The non-oxidic particles are used in amounts of from 1-50 wt. %. The amount of non-oxidic particles includes all values and subvalues therebetween, especially including 2, 3, 4, 5, 10, 15, 20, 25, 30, 35, 40 and 45 wt. %.

The particles have a particle diameter of from 0.1 nm to 100 μcm. The particle diameter includes all values and subvalues therebetween, especially including 0.5, 1, 5, 10, 20, 30, 40, 50, 60, 70, 80, 90, 100, 200, 300, 400, 500, 600, 700, 800, 900 nm, and 1, 2, 3, 4, 5, 6, 7, 8, 9, 10, 15, 20, 25, 30, 35, 40, 45, 50, 55, 60, 65, 70, 75, 80, 85, 90 and 95 μm. Particles impart mechanical strength to the coating when added in high percentage, at very low percentage they can act as catalysts.

In one embodiment, the coating system of the present invention contains 50-60 vol. % of solvent, 30-40 vol. % resin primer which includes up to 15 parts by weight of curing agent, up to 70 parts by weight of resin, up to 0.5 parts by weight of catalyst, and 8-12 vol. % hydrolyzed bis-amino silane.

In another embodiment, the coating system of the present invention contains 50-60 vol. % of solvent, 30-40 wt. % epoxy primer (composition of epoxy primer: 15 parts by weight of curing agent, 70 parts by weight of epoxy resin, 0.5 parts by weight of tin catalyst), and 8-12 vol. % hydrolyzed bis-amino silane.

In another embodiment, the coating composition of the present invention contains 30-60 wt. % n-butoxy ethanol, 20-50 wt. % of standard resin (primer) (containing 50-90 wt. % of epoxy resin, 10-30 wt. % of curing agent, and 0.05-1.5 wt. % of catalyst, preferably di-butyl tin dilaurate, DBTDL), 0.5-15 wt. % hydrolyzed bis-amino silane (containing 2-15 wt. % bis-amino silane, 2-15 wt. % water, 50-90 wt. % ethanol and 0.5-3 wt. % of acetic acid). Further, 60-99 wt. % of this coating composition may be mixed with 1 to 40 wt. % of the hydrophobic silane, preferably bis-sulfur silane and even more preferably A1289, without solvent or dissolved in 2-25 vol. % water and/or ethanol. Other suitable solvents include N-butoxy ethanol, methanol, and dimethyl formamide.

In another embodiment, the coating composition of the present invention contains 53.6 wt. % n-butoxy ethanol, 36.1 wt. % of standard resin (containing 81.87 wt. % of epoxy resin, 17.54 wt. % of curing agent, and 0.59 wt. % of catalyst, preferably i-butyl tin dilaurate, DBTDL), 10.5 wt. % hydrolyzed bis-amino silane (containing 6.86 wt. % bis-amino silane, 6,86 wt. % water, 84.32 wt. % ethanol and 1.96 wt. % of acetic acid).

The coating composition of the present invention is obtained by weighing and mixing the respective components, including a resin, a curing agent, a catalyst, a hydrolyzed amino-silane and optionally a hydrophobic silane and optionally a solvent. The mixing can occur in any mixer. This mixture is then coated on a cleaned substrate, preferably a metal substrate and cured at temperatures of from 100 to 160° C. The substrate can be cleaned using water or any other solvent or mixtures thereof. Metals are preferably cleaned in acetone and an alkaline cleaner such as an aqueous solution of KOH or NaOH in water. Other solvents for cleaning include hexane, and ethanol, alone or in mixtures. Acidic cleaners may also be used. It is preferred to use about 3-12 vol. %, more preferably 7.5 vol. % of the alkaline cleaner in water. The curing can occur in an oven or using a heating device such as a lamp. UV curing may be used, for example when curing (meth)acrylates.

Preferably, the silane and the primer are not aged. When only hydrolyzed silanes are used and not non-hydrolyzed silanes, the system can be aged as a one-component system. “Aging” means using the primer after a few days to a few months after mixing. The performance usually dips when the silane-primer system is aged, but when aged as silane and primer separately good performance is achieved even after months. In general, the primer and the silane are each stable after months. However, the combination of primer and silane has limited shelf life. Accordingly, it is preferable to keep the primer and the silane separately until just before use.

The substrate is not particularly limited. Preferably a metal substrate is used. Particularly preferred are cold-rolled steel and hot dip galvanized (HDG) steel. Aluminum can also be used. Concrete, plastics such as polyvinylchloride, polycarbonate, polyethylene, and polyethyleneterephthalate, stainless steel, electrogalvanized steel, copper and its alloys, magnesium alloys and wood are also suitable as substrates.

The coating procedure is not particularly limited. Preferred coating procedures are spraying, wiping, roll coating (viscosity is adjusted to be suitable for this method, for example by using a solvent), draw-down coating and brush coating.

The curing proceeds at high temperatures at about 100 to 160° C., preferably about 140° C. when blocked curing agents are used. Room temperature curing is possible when using, for example, unblocked polyisocyanates, preferably aliphatic or aromatic, unblocked amines, unblocked amides or unblocked imines. The curing may proceed for 1 to 60 minutes. The curing time includes all values and subvalues therebetween, especially including 5, 10, 15, 20, 25, 30, 35, 40, 45, 50 and 55 min.

In one embodiment, bis-amino silane is hydrolyzed for 30 minutes. At least 7 vol. % of bis-amino silane are added to 7 vol. % water and 86 vol. % ethanol. Hot dip galvanized metal is cleaned using acetone and alkaline cleaner. Epoxy primer made using epoxy resin, curing agent and tin catalyst is mixed with n-butoxy ethanol. Hydrolyzed bis-amino silane is mixed with the epoxy primer in a solvent. Particles and additional silanes may be added, for example, titania and alumina, both of nanometer size, and bis-triethoxy silyl benzene.

The coatings preferably have a thickness of 1 to 5000 μm, preferably 5 to 2500 μm, more preferably 10 to 1000 μm and most preferably 20 to 25 μm. The thickness of the coating includes all values and subvalues therebetween, especially including 2, 3, 4, 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, 100, 150, 200, 250, 300, 350, 400, 450, 500, 1000, 1500, 2000, 2500, 3000, 3500, 4000, and 4500 μm.

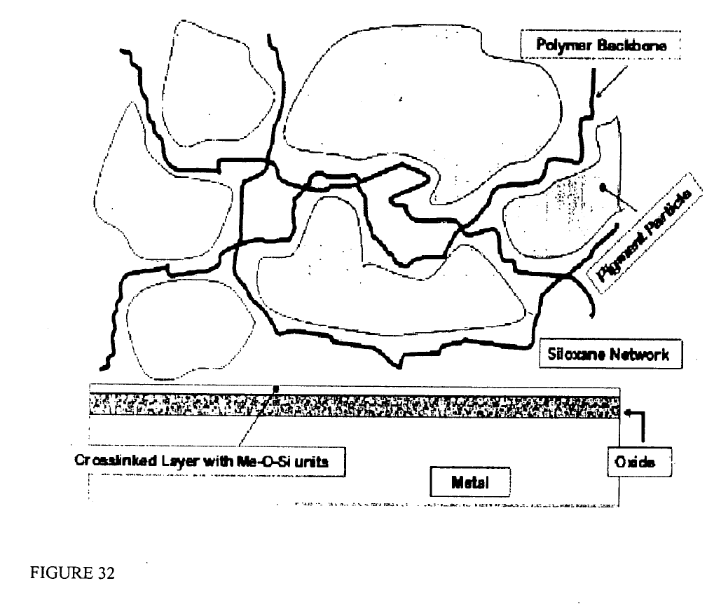

The coating composition according to the present invention is advantageous due to the presence of silane which does not react with the resin, while a reaction occurs between the curing agent and the resin. As a result two separate networks are built, one between the resin and the curing agent and one between the hydrolyzing and condensing silane. This can be seen from the NMR and IR data shown in the Examples below. In a preferred embodiment, the coating of the present invention is a dense three-dimensional siloxane network which is penetrated by the resin (FIG. 32).

Further, the coating system of the present invention does not require a pretreatment process, provides excellent adhesion between the substrate and the coating and therefore minimal delamination, thereby providing excellent corrosion resistance.

The coating system of the present invention may be used for automotive parts, particularly for replacing phosphate pretreatments; in the aerospace industry, for example for fuselage to replace chromated primers; for coating ship hulls; for floor coatings on concrete, particularly for adhesion, on floors in laboratories and on other materials which require chemical resistance; in the galvanizing industry, for example as primer in powder coatings; as sealant in concrete or brick, particularly to reduce the of penetration of water; for reinforcing bars in concrete, with or without epoxy primer to reduce corrosion; on plastics, for example to reduce the diffusion of CO₂ from plastic bottles containing beverages; as anti-fingerprint agent, for example on stainless steel or appliances to reduce sensitivity to fingerprints.

Having generally described this invention, a further understanding can be obtained by reference to certain specific examples which are provided herein for purposes of illustration only, and are not intended to be limiting unless otherwise specified.

### EXAMPLES

Characterization of the Coated Samples.

Electrochemical Impedance Spectroscopy (EIS), is an electrochemical technique used to determine in an accelerated way the performance of a coating on a metal. EIS curves were measured by software which collects signals from an apparatus containing a cell made of calomel and graphite electrodes, salt solution as electrolyte and the coating as dielectric and a potentiostat. The salt solution contains 3.5 wt. % or 0.6 M NaCl, saturated with oxygen.

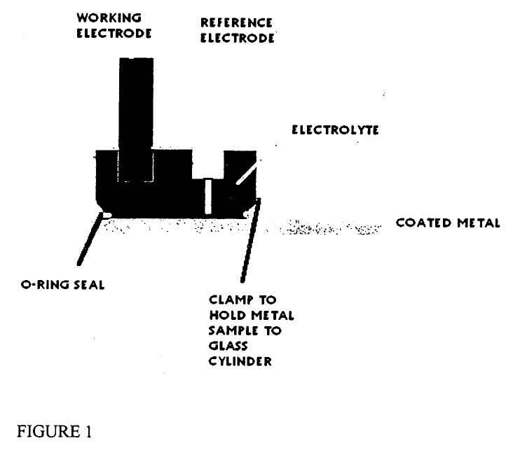

Electrochemical Impedance Spectroscopy measurements were carried out using an frequency response analyzer connected to a Gamry potentiostat. The measured frequency range was from 10⁻³ to 10⁵ Hz, with AC excitation amplitude of 10 mV. A saturated calomel electrode was used as the reference electrode and coupled with a graphite counter electrode. The distance between the electrodes and the tested area was around 6 cm. A set-up is shown in FIG. 1.

ASTM B-117 salt spray test: The test involved spraying the coated metals placed at an angle of 45° with 5% salt solution in a salt fog chamber of appropriate size. The coated Panels were constantly monitored on a day-to-day basis for identifying the first formation of corrosion.

### Example 1

The standard primer was obtained by mixing the following components shown in Table 1.

TABLE 1

| | | | Catalyst |
|---|---|---|---|
| | Epoxy | Crosslinker | (DBTDL) |
| Std. Primer | 81.87 | 17.54 | 0.59 |
| in wt. % | | | |

The hydrolyzed bis-amino silane was obtained by mixing the following components:

6.86 wt. % bis-amino silane,

6.86 wt. % water,

84.32 wt. % ethanol, and

1.96 wt. % acetic acid.

Preparation of an integral primer system (hereinafter SP3-7% or SP37)

The primer system was prepared by mixing the following components:

53.6 wt. % n-butoxy ethanol,

36.1 wt. % of standard primer, and

10.5 wt. % hydrolyzed bis-amino silane.

90 wt. % of SP3-7% was then mixed with 10 wt. % of the bis-sulfur silane A1289.

The silanes and the primer were used for coating immediately, and not aged. A hot dip galvanized steel was cleaned using acetone and alkaline cleaner. The metal was immersed in an acetone bath for 3 min. and then in alkaline cleaner and maintained at 60-65° C. for 5 mins. A draw-down bar was used for coating and the coated substrate was cured at 140° C. for 20 min.

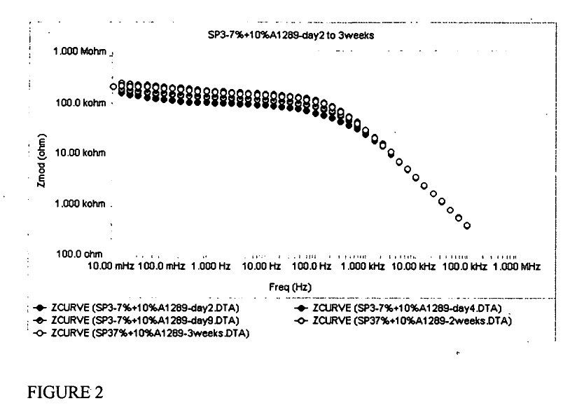

The EIS curve of the coating was measured and is shown in FIG. 2. The combination of bis-sulfur silane A1289 and SP3-7% yielded a positive change in the system. The EIS curve in FIG. 2 shows no change in properties even after 3 weeks in salt immersion. No corrosion products were formed at the surface during salt immersion even after 3 weeks. The bis-sulfur silane also hydrolyzed well and helped in the formation of a denser siloxane network. The silane in the coating system according to the present invention does not react with the epoxy resin; it hydrolyzes first and then condenses to form a 3-D siloxane network interpenetrated with the epoxy, the siloxane network is hydrophobic and provides corrosion protection.

### Example 2

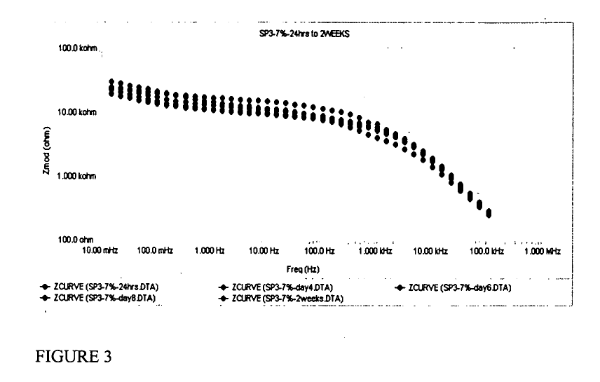

The procedure of Example 1 was repeated except, the SP3-7% system was used for coating without the addition of A1289. As shown in FIG. 3, this system that has yielded results that are better those of conventional systems. This system also has passed a 336 h ASTM B-117 salt spray testing. FIG. 3 shows the EIS behavior of the coating for up to 2 weeks.

### Example 3

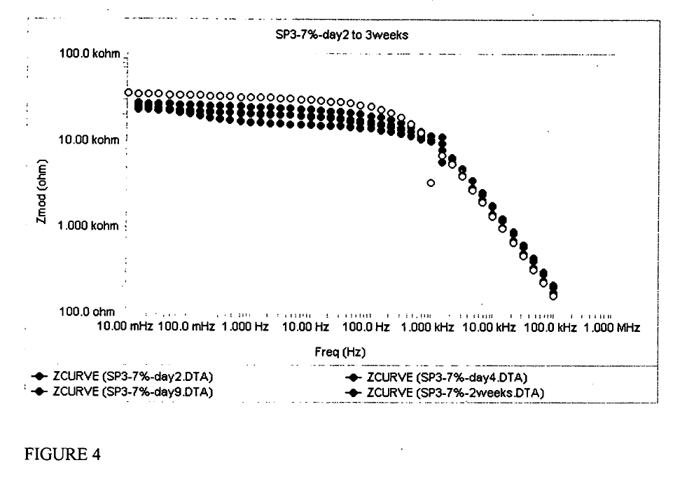

The procedure of Example 2 was repeated. FIG. 4 shows the EIS behavior of the system for up to 3 weeks.

### Example 4

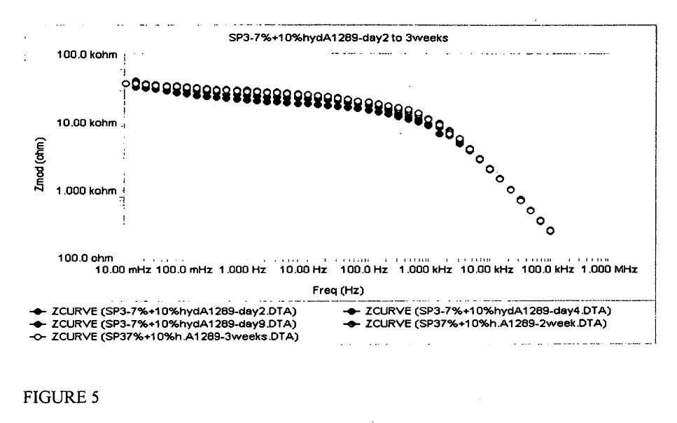

The procedure of Example 1 was repeated, except that hydrolyzed A1289 was used. 7 vol. % A1289, 7 vol. % water and 86 vol. % ethanol were mixed to hydrolyze the A 1289. FIG. 5 shows the EIS behavior of the system for up to 3 weeks. Again no changes occurred in properties after 3 weeks of salt immersion.

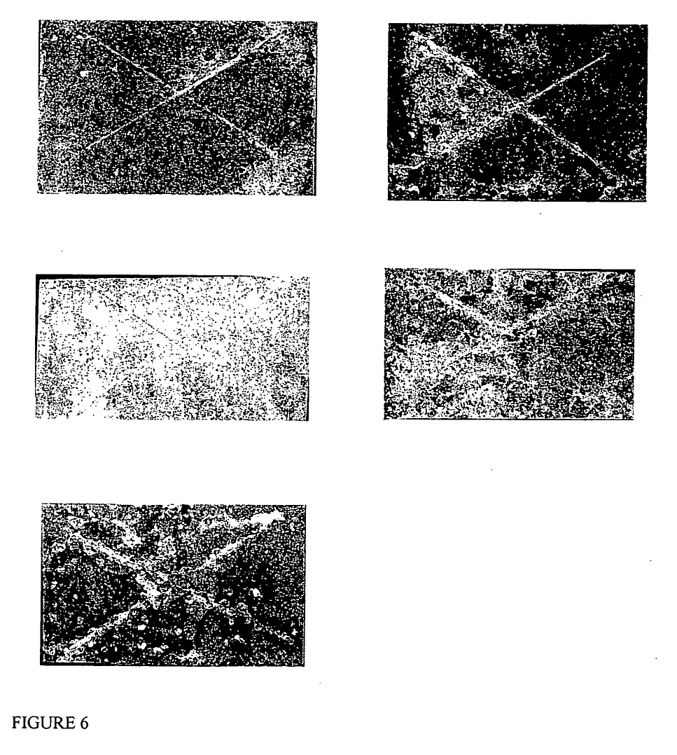

FIGS. 6-9 show the results of the salt spray test.

The samples were immersed completely in 3.5 wt. % NaCl salt solution and kept upright, i.e. at 90° to the base. Formulations for the coatings shown in these figures are shown in Tables 2-4.

TABLE 2
SUPER PRIMER PREPARATION (wt. %)

| | n- | std. | std. | | | | | | | |
|---|---|---|---|---|---|---|---|---|---|---|
| superprimer | butoxy | primer | primer | silane | | | | | | epoxy/ |
| (SP) type | ethanol | 1 | 2 | A | B1 | C1 | C2 | C3 | C4 | silane |
| SP 2 | 50.85 | 34.4 | | 10 | 4.75 | | | | | 3.39 |
| SP 3 - 2% | 53.4 | | 36.1 | | | 10.5 | | | | 120.33 |
| SP 3 - 4% | 53.4 | | 36.1 | | | | 10.5 | | | 60.15 |
| SP 3 - 7% | 53.4 | | 36.1 | | | | | 10.5 | | 34.40 |
| SP 3 - 10% | 53.4 | | 36.1 | | | | | | 10.5 | 24.40 |
| SP 4 - 2% | 48.6 | | 33.06 | | | 18.04 | | | | 64.15 |
| SP 5 - 2% | 45.3 | | 30.6 | | | 24.1 | | | | 44.44 |

TABLE 3
PRIMER PREPARATION (Weight %)

| | | | catalyst 1 | |
|---|---|---|---|---|
| | | | (stannous | catalyst 2 |
| | epoxy | crosslinker | laurate) | (DBTDL) |
| std. primer 1 | 81.87 | 17.54 | 0.59 | |
| std. primer 2 | 81.87 | 17.54 | | 0.59 |

TABLE 4
SILANE PREPARATION (Volume %)
silane type

| | | B | | | | |
|---|---|---|---|---|---|---|
| | A | (diluted | | | | |
| | (silane, | silane) | C (hydrolyzed silane) | | | |
| components | as is) | B1 | C1 | C2 | C3 | C4 |
| bisamino silane | 100 | 1.9 | 1.9 | 3.96 | 6.86 | 9.75 |
| ethyl alcohol | | 98.051 | 96.151 | 91.09 | 84.32 | 78.05 |
| acetic acid | | 0.049 | 0.049 | 0.99 | 1.96 | 2.45 |
| water | | | 1.9 | 3.96 | 6.86 | 9.75 |

In FIG. 6, the first row of photographs shows: left: SP3-7%, right: SP3-4%. The second row shows left: SP3-10%, right: SP4-2%. The third row shows: SP3-2%.

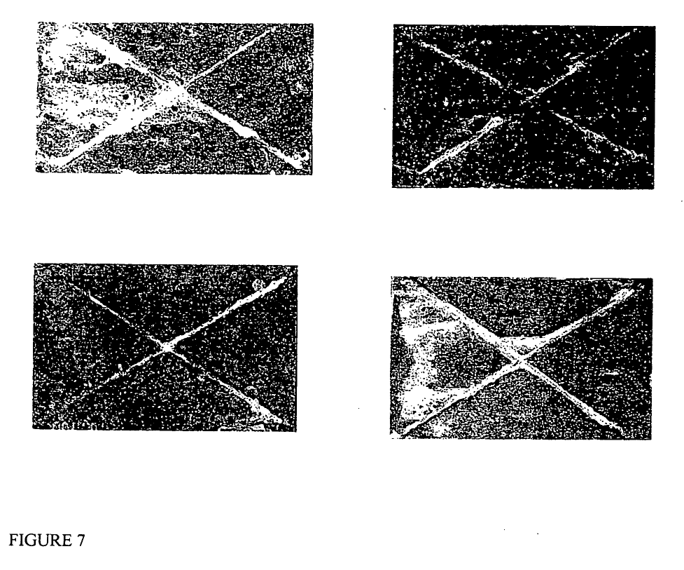

In FIG. 7, the top left Panel is P/Si which is a two-step coating: the std. primer (P) was coated over a silane pretreated hot-dip galvanized steel. The aim of the integral resin-silane system is to replace the pretreatment and std. primer with the integral resin-silane system. The top right was just std. primer coated over bare hot-dip galvanized steel. The bottom left was SP5-2% and bottom right was SP-2%.

As can be seen from FIGS. 6-9, among the 9 coatings, the best result were seen using SP3-7% which shows the least corrosion products and performed better than P/Si. Others coatings show either uniform corrosion, pits or corrosion under the coating.

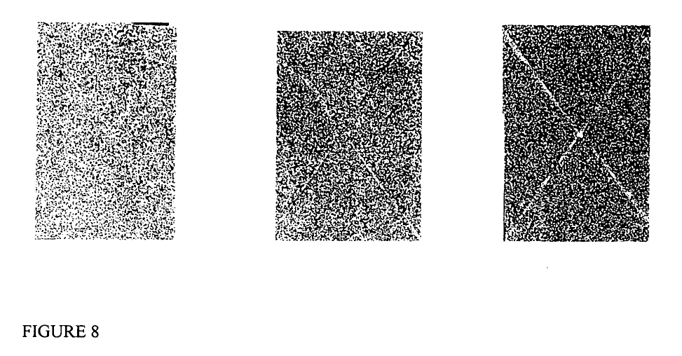

FIG. 8 shows a comparison of the results of the salt spray test from left to right as follows:

Left: salt spray test of Example 1 (SP3-7%+10% A1289).

Middle: salt spray test of Example 2 (SP3-7%).

Right: salt spray test of Example 4 (SP3-7%+10% hydrolyzed (hydr.)A1289).

As can bee seen, Examples 1, 2 and 4 passed the 336 hour salt spray test. In addition, Example 1 shows better performance than Example 2.

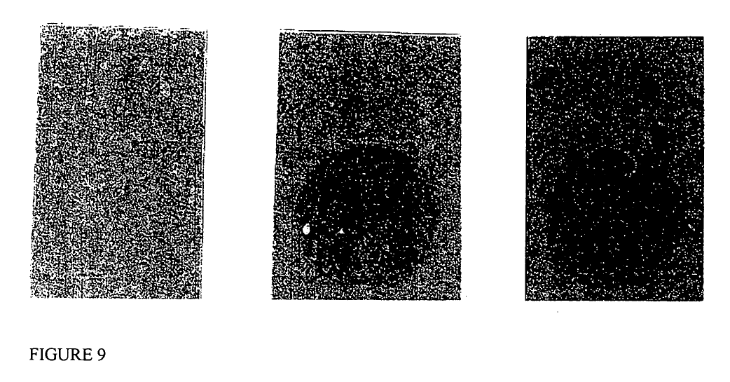

FIG. 9 shows the results after 3 weeks of salt immersion (area under circle).

The samples were completely immersed in 3.5 wt. % NaCl salt solution and kept upright, i.e. at 90° to the base.

The comparison of the results of the salt spray test from left to right is as follows:

Left: salt spray test of Example 1 after 3 weeks of salt immersion (SP3-7%+10% A1289).

Middle: salt spray test of Example 2 after 3 weeks of salt immersion (SP3-7%).

Right: salt spray test of Example 4 after 3 weeks of salt immersion (SP3-7%+10% hydr.A1289).

It is clearly seen, while all 3 systems show very little corrosion effects, the system on the left (Example 1) shows almost none.

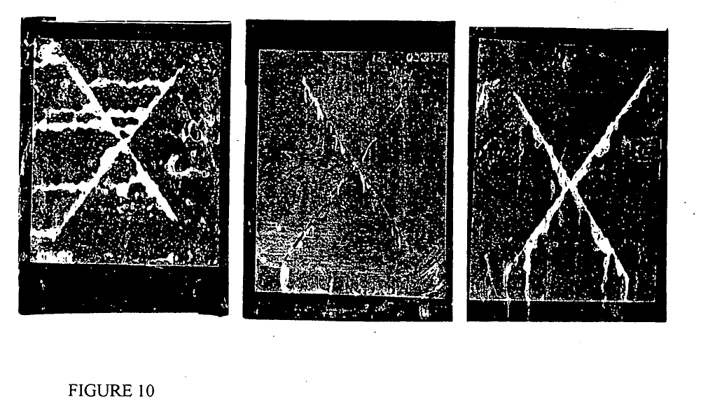

FIG. 10 shows the results of the salt spray test after 168 hours. The salt spray test is based on the ASTM B-117 standard test. The Panels were kept at a 45° angle in a salt fog chamber and 5 wt. % NaCl salt solution was sprayed on the Panels continuously for 168 hrs.

Left: salt spray test of Example 2 after 168 hours. There were corrosion products in the scribe and some pits, no delamination.

Middle: salt spray test of Example 1 after 168 hours. There was no corrosion, very little corrosion product in the scribe, no delamination, no pits.

Right: salt spray test of Example 4 after 168 hours. There were corrosion products in the scribe, no delamination, no pits.

### Example 6

IR and ¹H-NMR Characterization of Silane-Incorporated Primer.

The pure (used as is) and hydrolyzed silanes and epoxy resin were analyzed using a Biorad FTS-40 equipment in the transmission mode (resolution 8 cm⁻¹). The samples were prepared using potassium bromide pellets. The spectra of epoxy resin, curing agent and silanes were taken individually and also in mixtures to observe the changes in chemistry. The pellet was also used to prepare samples obtained from dry films in powder form.

¹H-NMR was used to analyze the silane-primer films. The film was scrapped from the metal using a sharp knife and crushed to fine powder. This powder was dissolved in deuterated chloroform. Silanes in pure (used as is) and hydrolyzed forms were also analyzed. A Bruker AMX 400 instrument was used for the analysis and the number of scans for each sample was 8.

The silane-incorporated primer consisted of (dry film)

1. epoxy resin (DGEBA epoxy resin obtained from BASF, Germany),

2. polyisocyanate as the curing agent,

3. dibutyltin dilaurate (DBTDL),

4. hydrolyzed bis-amino silane,

5. non-hydrolyzed bis-sulfur silane (in some cases hydrolyzed as discussed below),

The standard primer (std. primer) was prepared by adding 15 parts by weight of curing agent to 70 parts of epoxy and 0.5 parts of DBTDL. About 50% by volume of n-butoxy ethanol was added. The epoxy resin, the curing agent and DBTDL were mixed in a beaker using a glass rod and after achieving a homogeneous mixture, this mixture was added to the solvent and again mixed thoroughly.

The silane-incorporated primer was prepared by adding 7% hydrolyzed bis-amino silane and non-hydrolyzed bis-sulfur silane. The 7% hydrolyzed bis-amino silane was added in a small quantity and hence did not show up in the IR, but the dry film consisted of 25% by weight of bis-sulfur silane(A1289) and this was seen in the IR spectra. The silanes, both, the hydrolyzed bis-amino silane and the non-hydrolyzed bis-sulfur silane were added to the std. primer directly and mixed well to form a homogeneous mixture.

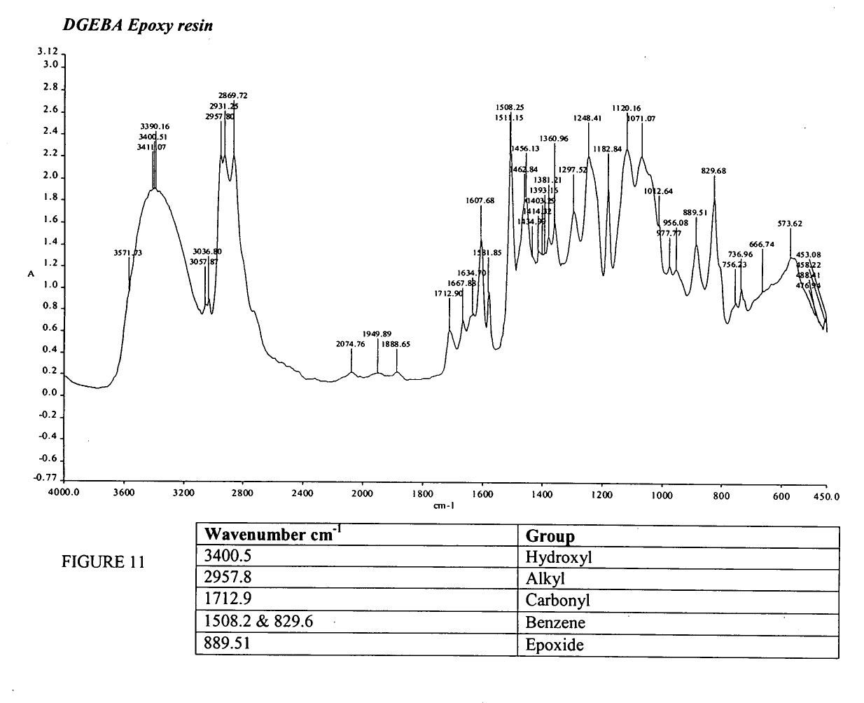

FIG. 11 shows the IR spectrum of DGEBA epoxy resin.

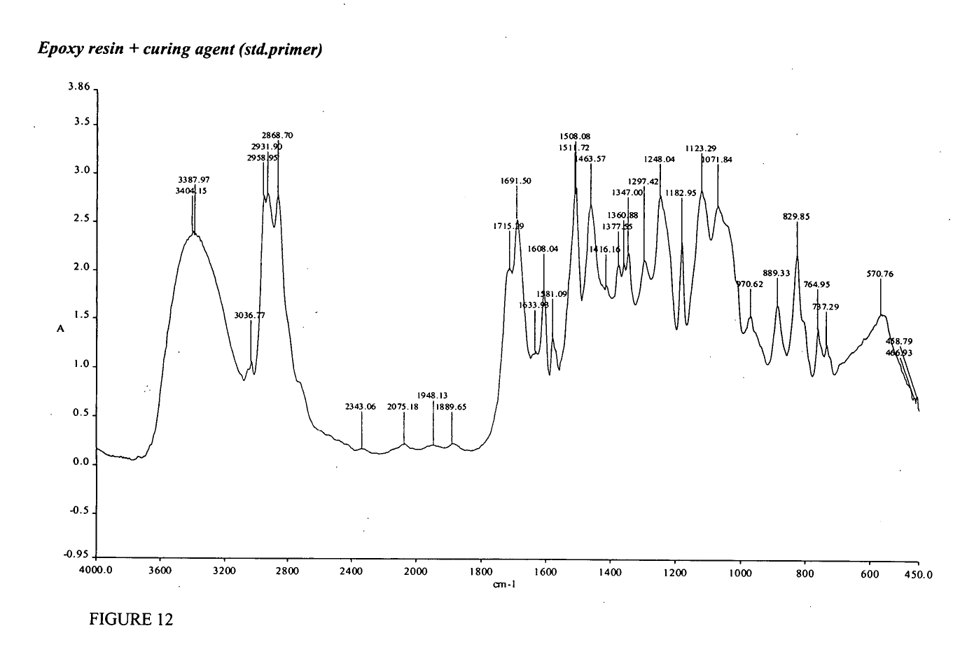

FIG. 12 shows the IR spectrum of epoxy resin+curing agent (std. primer). The functional groups characteristic of epoxy resin were all present, including the reactive epoxide group seen at 889.3 cm⁻¹. This was the IR of the standard primer in liquid form just before the coating and curing process. At this stage, the epoxy resin and the curing agent had not reacted as the curing agent was blocked.

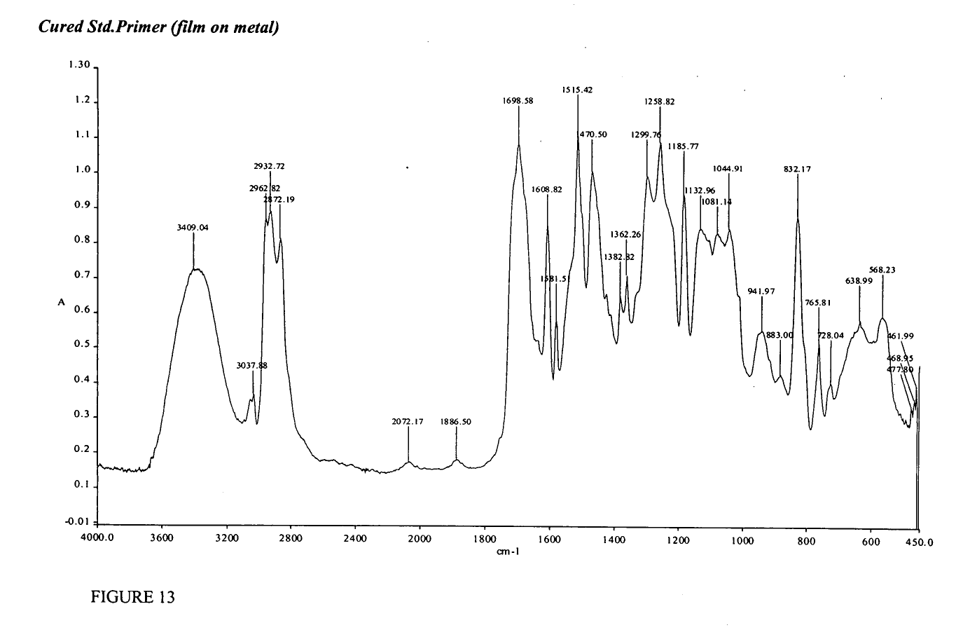

FIG. 13 shows the IR spectrum of the cured std. primer (film on metal). The curing agent was unblocked and reacted with epoxide and hydroxyl groups in the epoxy resin present in the std. primer. This is clear as the peak at 889.3 cm⁻¹ disappeared, a very small intensity peak at 883 cm⁻¹ was seen instead. This confirmed the epoxide bond break. The hydroxyl group at 3400 cm⁻¹ range was at a reduced intensity here, showing some of the hydroxyl groups in the epoxy resin may have crosslinked.

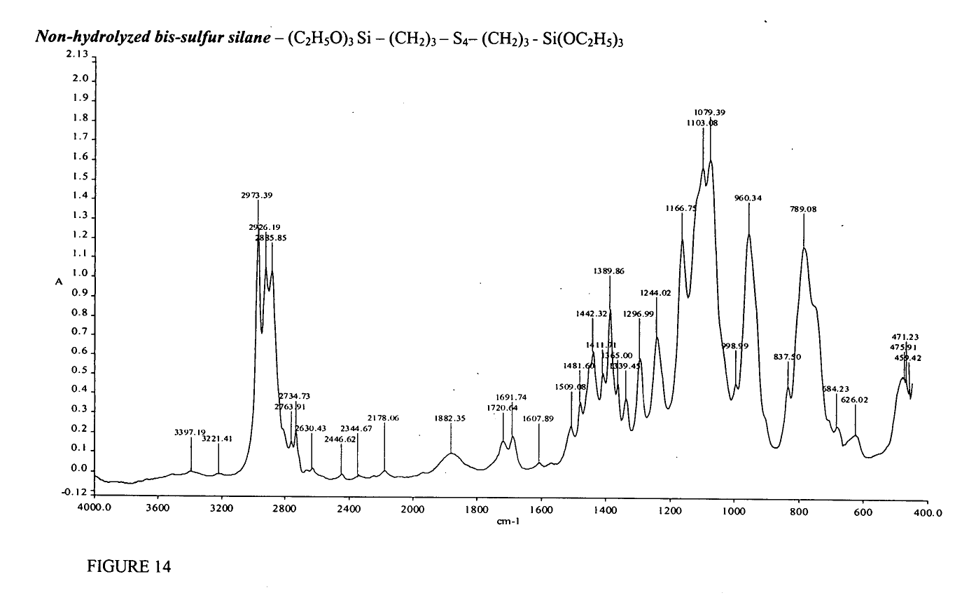

FIG. 14 shows the IR spectrum of the non-hydrolyzed bis-sulfur silane: (C₂H₅O)₃ Si—(CH₂)₃—S₄—(CH₂)₃—Si(OC₂H₅)₃. The likely reacting group were the end groups (C₂H₅O)₃ Si. These can hydrolyze and form silanols (Si—OH) and further condense to form an —Si—O—Si— network. However, there was no water in the paint for this reaction to occur. The other way for this reaction to occur is to absorb moisture from air, or absorb water when immersed in salt water. Another reaction possibility is the reaction between epoxy resin and bis-sulfur silane. The peak at 960 cm⁻¹ was critical, it belonged to Si—O asymmetric stretching of SiOC in Si(OC₂H₅)₃.

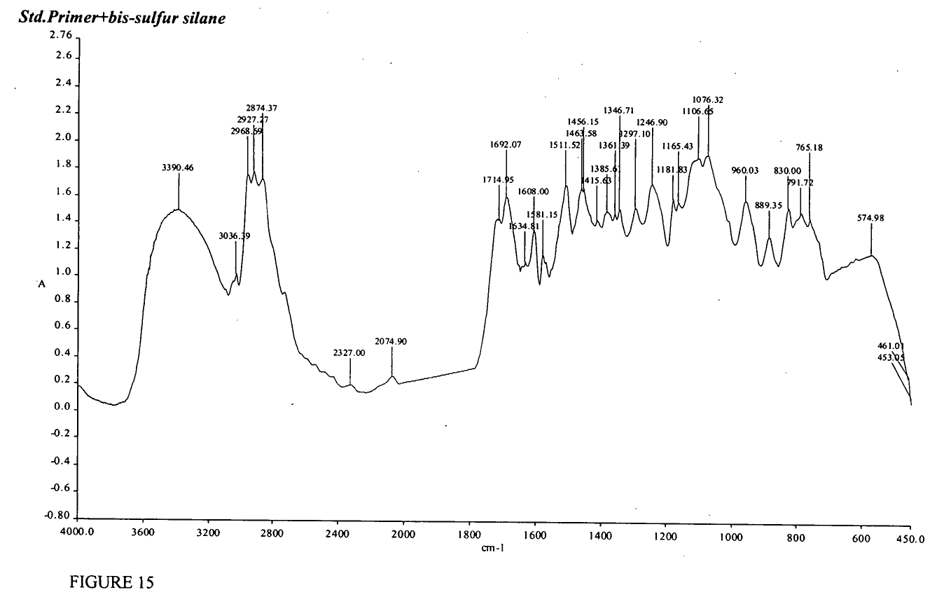

FIG. 15 shows the IR spectrum of the std. primer+bis-sulfur silane. All peaks characteristic of epoxy resin and bis-sulfur silane were seen. Therefore when the silane-incorporated primer had not yet been made in to a film on metal, there seemed to be no reaction of epoxy resin with either the curing agent or bis-sulfur silane.

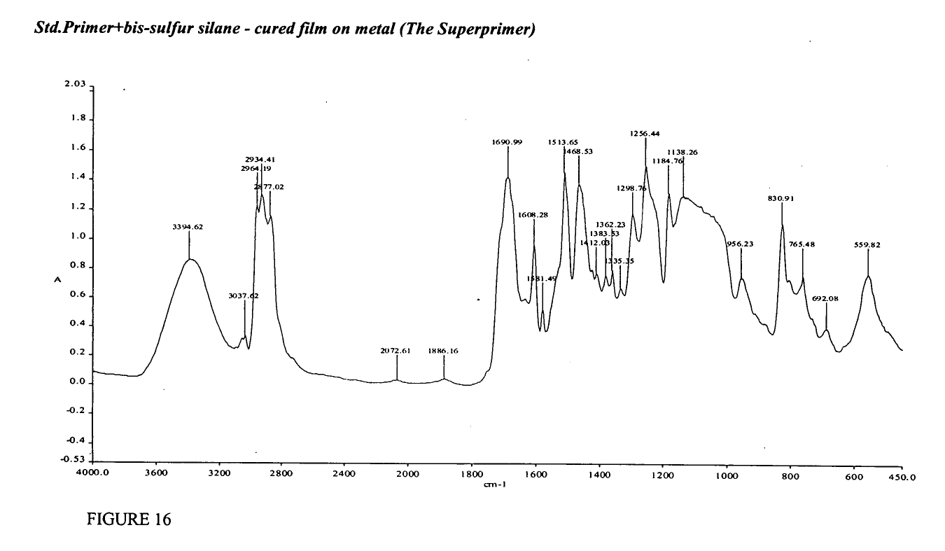

FIG. 16 shows the IR spectrum of the std. primer+bis-sulfur silane, a cured film on metal. The peak at 889 cm⁻¹, characteristic of the epoxide group, has disappeared showing that the epoxide was opened. The inventors of the present invention have seen a similar trend in the cured std. primer film on metal IR. It was confirmed there that the curing agent was responsible for the epoxide bond break. Here though because bis-sulfur silane was also present it had to be ascertained whether it was curing agent or bis-sulfur silane that was responsible for the epoxide break. Since the C—H at 2973 cm⁻¹ seen in the bis-sulfur IR was unaffected and more importantly because of the presence of Si—O asymmetric stretching of SiOC in Si(OC₂H₅)₃ at 956 cm⁻¹ it was clear that bis-sulfur silane had not reacted. Accordingly, curing agent and epoxy resin formed a network and silane in the system formed another network and helped in corrosion protection and adhesion to topcoat through the free functional groups available ((Si(OC₂H₅).

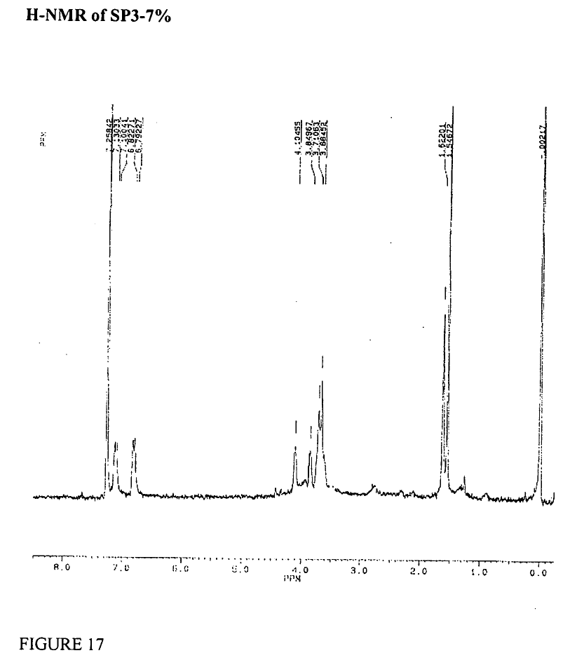

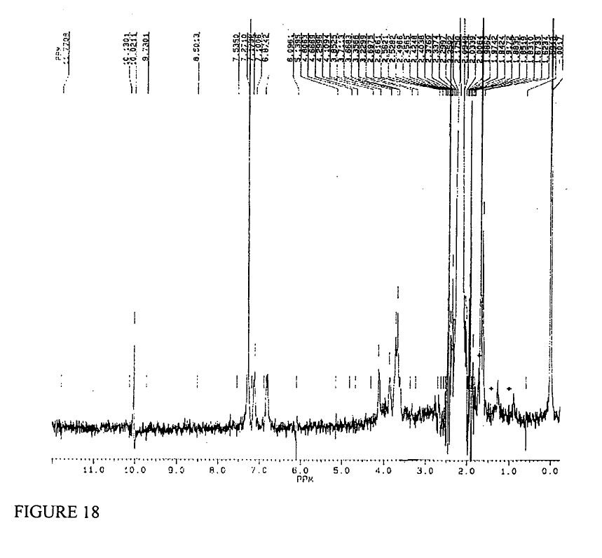

FIG. 17 shows the ¹H-NMR spectrum of the SP3-7% containing epoxy resin (DGEBA type epoxy resin, obtained from BASF, Germany), curing agent (polyisocyanate) and hydrolyzed bis-amino silane (7% vol. of bis-amino silane is hydrolyzed and 10.5% wt of this was used in the coating system of epoxy resin and curing agent). The spectrum shows the same pattern of products as in the ¹H-NMR of FIG. 18 (epoxy+curing agent). However, here, 7 vol. % of hydrolyzed silane has been added. This 7% is the amount of silane percentage that is hydrolyzed and not the total percentage of silane in the whole coating system (see Example 1). From the spectrum it is clear that the epoxy did react with the curing agent and not with the silane. The silane addition has not altered the reaction mechanism between epoxy resin and curing agent.

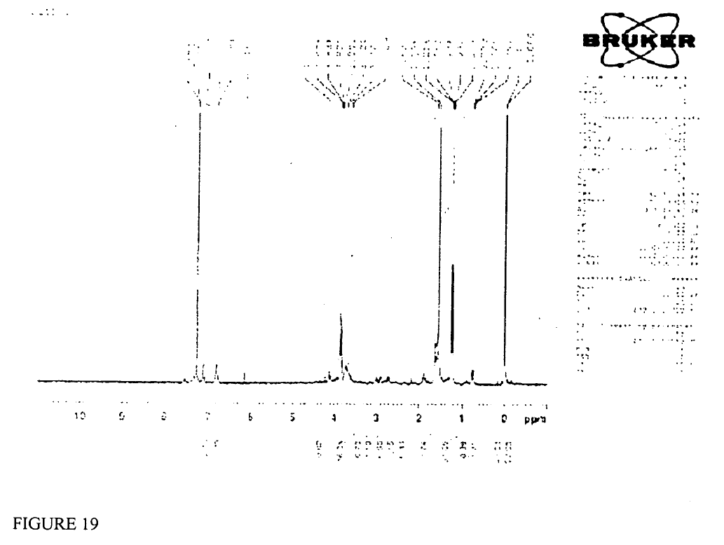

FIG. 19 shows the ¹H-NMR spectrum of the SP3-7% mixed with 10 vol. % of A1289 (bis-sulfur silane). The spectrum shows the characteristic peaks of SP3-7% coating. The aromatic protons on either side of 7 ppm, and the —CH₂O— peak at 3.7 ppm. The height ratio between these peaks also remains the same. Therefore, since the protons of SP3-7% coating were retained in this coating, the bis-sulfur silane has not really interfered with the reaction mechanism seen in the SP3-7% coating. The new peaks at 3.8 ppm and 1.2 ppm show the protons belonging to —OCH₂— and —(OCH₂)CH₃, respectively. Thus, the reacting group in bis-sulfur silane: (OC₂H₅)₃Si— has not been affected while was still fresh (i.e. not immersed in salt solution). Therefore, the silane was free to hydrolyze and condense resulting ultimately in enhanced corrosion protection due to the bis-sulfur silane.

### Example 7

Electrochemical Impedance Spectroscopy Results of the Coating Composition According to the Present Invention Which Includes Titania Nanoparticles.

Control Coating

The coating solution of Example 1 which includes 90 wt. % of SP3-7% and 10 wt. % of the bis-sulfur silane A1289 was used as a control. The coating was prepared as in Example 1. The thickness of the control coating was 15 μm.

Preparation of Titania Containing Solution

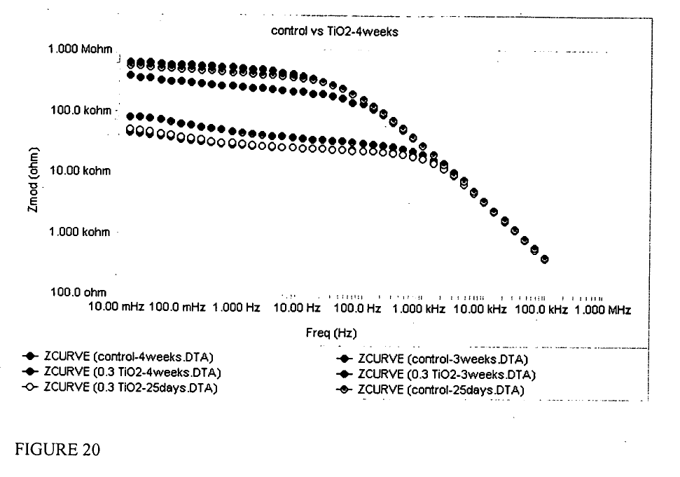

The coating solution of Example 1 was used and titania was added so that the final solution contained 1800 ppm of titania having a particle size of 5 microns, obtained from Nanoactive.com. The titania was added to the solvent and this dispersion was used to prepare the integral resin silane system. The coating obtained from the titania containing coating composition had a thickness of 13 μm. FIG. 20 shows the EIS data of the control coating and the coating having titania for a time period of four (4) weeks. The total resistance decreased with time, but the solution resistance of both coatings remains constant. That means the pore resistance reduced with time which indicates that after 4 weeks both coatings have developed pores through which the electrolyte had started seeping in. This can threaten the integrity of the coating itself. But for a thickness of 13-15 μm and a time period of 4 weeks these were good results.

### Example 8

Electrochemical Impedance Spectroscopy Results of the Coating Composition According to the Present Invention Which Includes Alumina Nanoparticles.

Control Coating

The coating solution of Example 1 which includes 90 wt. % of SP3-7% and 10 wt. % of the bis-sulfur silane A1289 was used as a control. The coating was prepared as in Example 1. The thickness of the control coating was 15 μm.

Preparation of Alumina Containing Solution

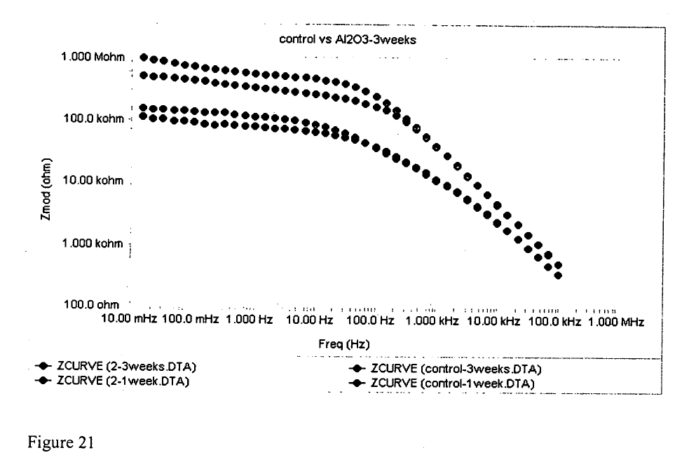

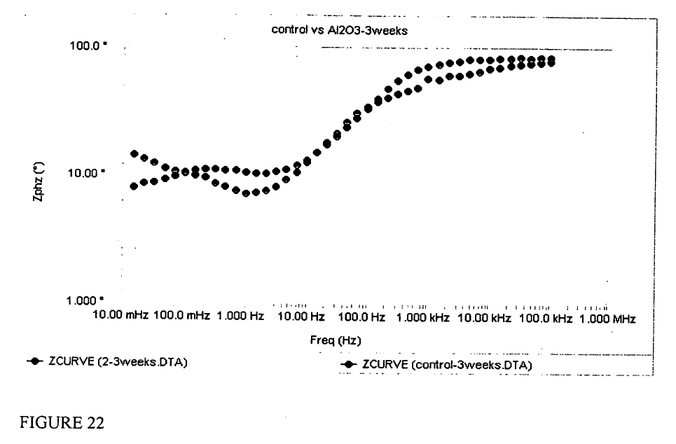

The coating solution of Example 1 was used and alumina was added so that the final solution contained 1000 ppm of alumina having a particle size of 40 nm (ALUMINASOL 100 from Nissan Chemical America Corporation). Alumina was added to the solvent and this dispersion was used to prepare the integral resin silane system The coating obtained from the alumina containing coating composition had a thickness of 10 μm. FIGS. 21 and 22 show the EIS data of the control coating and the coating having alumina for a time period of three (3) weeks. FIG. 21 shows the impedance in log scale in varying frequencies, this is shown as modulus vs. frequency curve. FIG. 22 shows phase angle which gives information about the different elements in the circuit if the coating system is drawn as an electrical circuit with different resistances such as polymer structures and layers. The phase angle curve (in FIG. 22) of the alumina-containing primer showed only two time constants even after 3 weeks, an excellent result. Also the thickness of the coating had not changed in 3 weeks. The two curves (1 week and 3 week curves) are overlapping each other showing that the electrical properties were intact from weeks 1 to 3. Since properties change if the thickness changes, the thickness must have remained the same. This is shown in the modulus curve (in FIG. 21) where the 1 week and 3 week curves of the alumina-containing primer are almost at the same positions except at the total resistance. With thickness not changing and only slight decrease in total resistance of the coating, alumina proved to be an excellent nanoparticle for the primer.

### Example 9

Electrochemical Impedance Spectroscopy Results for SP3-7%+A1289 (Contains Bis-Amino Silane) and SP3-7%+A1289−A1170 (Contains No Bis-Amino Silane)

The coating composition of Example 1 was compared to a coating composition having no bis-amino silane. This coating was prepared in the exact same manner as the first coating except that the hydrolyzed bis-amino silane was not added to the second one.

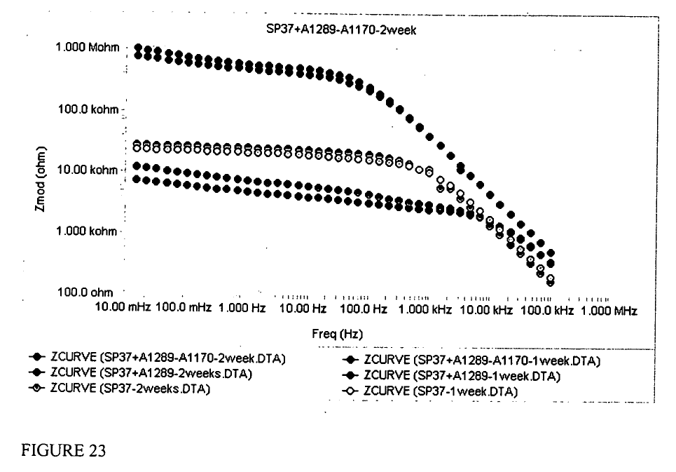

FIG. 23 shows EIS data comparing SP3-7%+A1289 (contains bis-amino silane) and SP3-7%+A1289−A1170 (contains no bis-amino silane) and just SP3-7% using a modulus vs. frequency curve which gives information about pore resistance and total resistance of the coatings. SP37-1 and SP37-2 refer to SP3-7% seen once in the first week and then in the second week, respectively.

The thicknesses of the 3 types of coatings shown in FIG. 23 varies, however the trend of the modulus curves over two weeks indicates the quality of the coating in terms of its corrosion resistance. SP37+A1289 and SP37, both containing bis-amino silane, showed no change in total resistance, indicating the coating was still able to absorb the water without allowing penetration through the coating, This was possible only due to a chemical activity in the coating. This trend was not seen in SP37+A1289−A1170, which does not contain bis-amino silane. This shows that the presence of bis-amino silane is beneficial for the performance of the coating.

### Example 10

Salt Immersion Results for Particle Containing Coatings

In the salt immersion test, a 3.5 wt. % solution of NaCl in deionized water was prepared and added to a flat glass container. The Panels were immersed in this bath at a 90° angle to the base of the container. The Panels were taped at the edges and scribed diagonally.

The coatings as described below were immersed for one month in 3.5 wt. % NaCl.

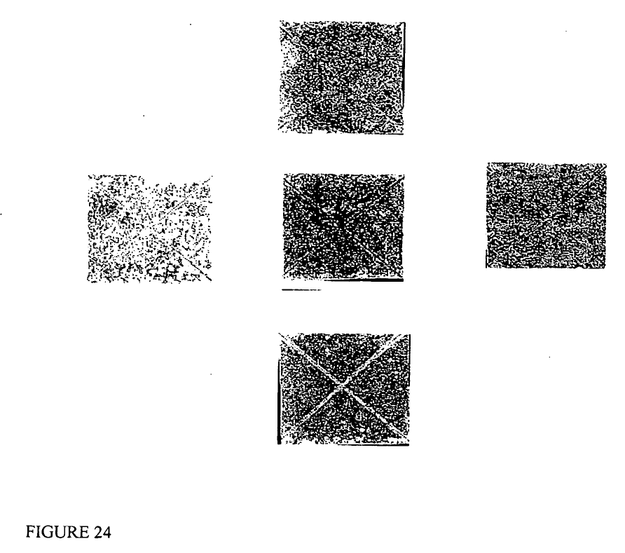

FIG. 24 shows the salt immersion results. The Panel in the middle is the control according to Example 1. To the right is control+titania according to Example 7. To the left is the control+sodium vanadate, bottom is control+MAZON inhibitor (a BASF inhibitor, alkanoid amine), top is control+bis-(triethoxy silyl) benzene. The particles were added to the solvent and stirred. After attaining a homogeneous solution, the particle-containing solvent was used to prepare the integral resin silane primer. The bis-(triethoxy silyl) benzene was simply added to the integral resin silane. Hot-dip galvanized steel was coated with the respective integral resin primers. The inhibitors sodium vanadate and MAZON failed, pits were seen on the surface. Yet MAZON has very little other corrosion effects. Titania and the bis-(triethoxy silyl) benzene containing coatings performed well. The titania containing primer had lesser corrosion effects near the scribe.

### Example 11

Salt Immersion Results for SP3-7%, SP3-7%+A1289 and SP3-7%+A1289−A1170

The coatings as described below were immersed for 11 days in 3.5 wt. % NaCl.

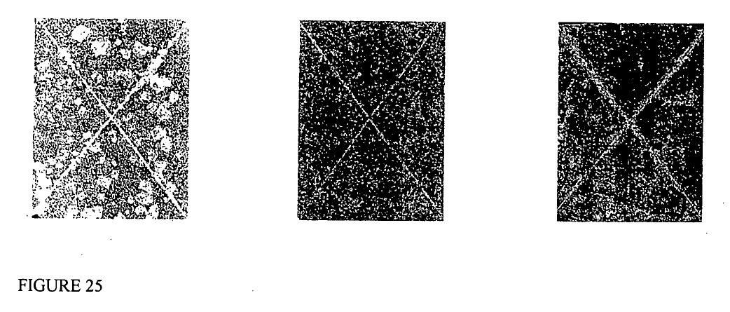

FIG. 25 shows the results of the salt immersion test. The Panel on the left shows SP3-7%+A1289−A1170. The Panel in the middle shows SP3-7%+A1289. The Panel on the right shows SP3-7%. The above result confirms the EIS result. The Panel in the middle has very little corrosion effects, the Panel in the left which has no bis-amino silane has pitted. Thus, inclusion of bis-amino silane in the primer formulation is advantageous.

### Example 12

SEM/EDX Results

A Hitachi S3600 SEM/EDX was used to characterize the film structure. The samples were metallized by gold sputtering to prevent any charging on the surface. 3.0075 keV and 2.2475 keV incident energy was used for in-situ EDX information. The spectra were taken after preparing the sample (1 cm×1 cm) and placing it inside the vacuum chamber. The sample was observed at 500× and the point of contacts of the X-ray beam were chosen carefully.

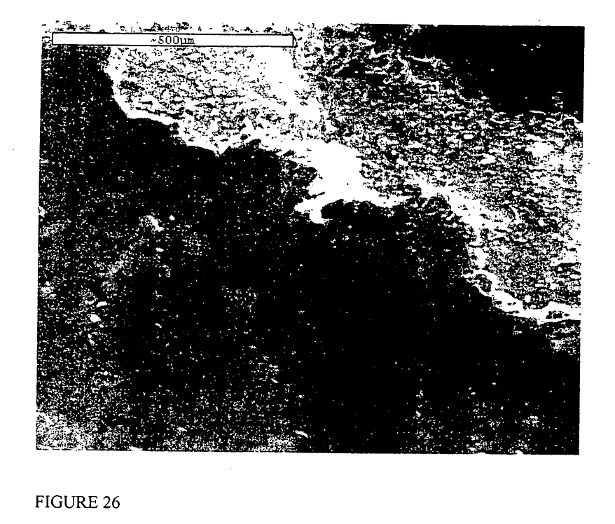

FIG. 26 shows the SEM results of the coating according to Example 1 immersed in a 3.5 wt. % NaCl solution for a week. Negligible presence of corrosion products is observed, the coating did not deteriorate.

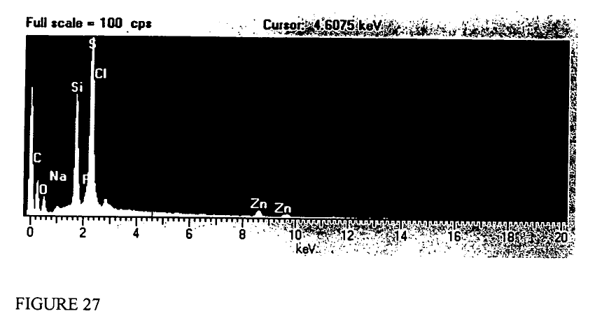

FIG. 27 shows the EDX results of the coating according to Example 1 immersed in a 3.5 wt. % NaCl solution for a week. The presence of S, Si and O is due to the silane coating. Zn is shown since the X-rays perform depth profiling, Zn present beneath the coating was detected.

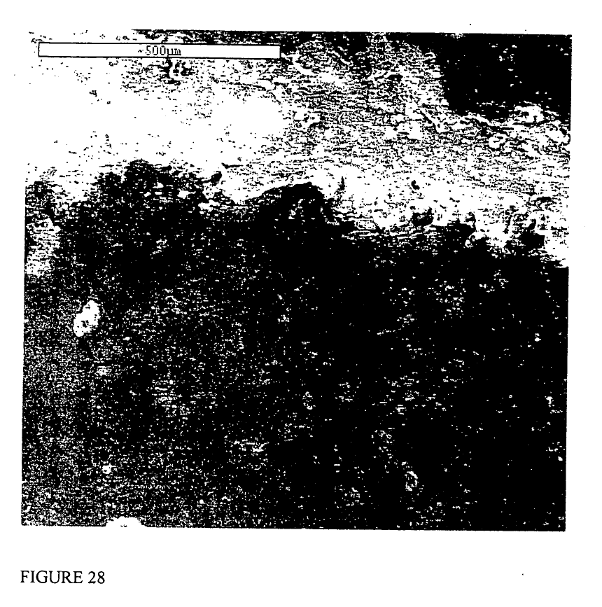

FIG. 28 shows the SEM results of the coating according to Example 7 immersed in a 3.5 wt. % NaCl solution for a week. Negligible presence of corrosion products was observed. The coating did not deteriorate.

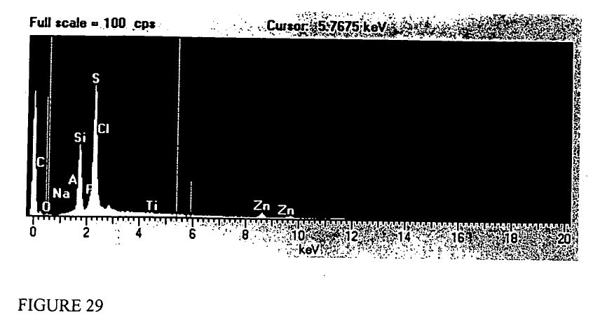

FIG. 29 shows the EDX results of the coating according to Example 7 immersed in a 3.5 wt. % NaCl solution for a week. Ti is shown due to presence of titania.

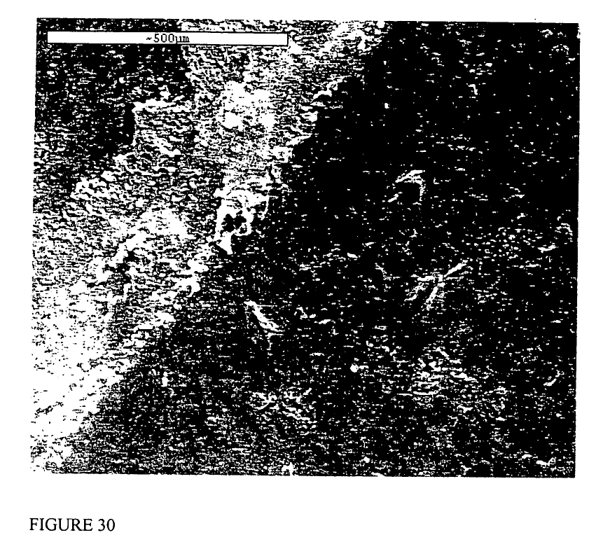

FIG. 30 shows the SEM results of the coating according to Example 8 immersed in a 3.5 wt. % NaCl solution for a week. Negligible presence of corrosion products was observed. The coating did not deteriorate.

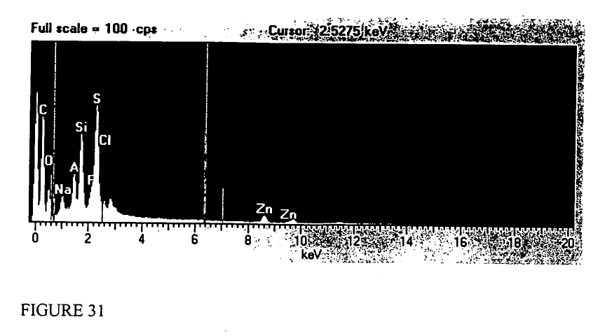

FIG. 31 shows the EDX results of the coating according to Example 8 immersed in salt solution for a week. Al is shown due to presence of alumina.

Both alumina and titania are detected in the coating surface and not in the scribe (EDX of coating surface is shown, EDX of scribed surface not shown here). Thus protection of the scribe of the titania containing coating is not attributed to leach out of titania to the scribe.

### Example 13

Contact Angle Measurements

Contact angle measurements were performed using a VCA-2000™ instrument from AST Products Inc. By viewing small droplets of liquid on a surface in profile, the effects of interfacial tension can be readily observed. In order to define these droplet profiles, a line tangent to the curve of the droplet is drawn by the software at the point when the droplet intersects the solid surface. The angle formed by this tangent line and the solid surface is called the contact angle.

Contact angle measurements were taken for SP3-7%, SP3-7%+A1289 AND SP3-7%+A1289−A1170. There was no difference in contact angle between the coating that was immersed in a 3.5 wt. % NaCl solution for 2 weeks and a fresh coating of SP3-7%, the contact angle was 60 and 61°, respectively. This is also observed in SP3-7%+A1289 where both the fresh and the immersed coatings had a contact angle of 85° each. “Fresh” means that the contact angle was measure immediately after preparation of the coating.

It is interesting to note how the contact angle increased from 60 to 85 degrees when A1289 was introduced in the system. This confirms the fact that A1289 is hydrophobic. The SP3-7%+A1289−A1170 coating showed a very low contact angle of 57° (fresh) and 60° when immersed in salt solution. This suggests that the hydrophobicity of the coating is enhanced when both A1289 and A1170, bis-sulfur and bis-amino silane, are present in the system, without either one of them the contact angle seems to dip in value. Therefore, as seen in the EIS data and salt immersion data, the presence of hydrolyzed bis-amino silane is preferred.

### Example 14

Adhesion Test Results

The test was performed according to ASTM D 3359 METHOD B specifications using a Gardco P-A-T Paint Adhesion Test Kit purchased from Gardco Company. Using the tool in the paint kit the coated Panels were scribed and the tape from the same kit was stuck on to the scribes, and then the tape was swiftly ripped off and the Panel was observed. This is the dry adhesion test.

In the wet adhesion test, the scribes were immersed in deionized water for 48 hours and then thoroughly dried and then the tape was stuck on the scribes and ripped off. The number of squares in the scribe where the paint has been scrapped off determines the classification mentioned in the ASTM test. Table 5 below shows the amount of flaking for each classification.

TABLE 5

| Surface of cross-cut area | | | | | | |
|---|---|---|---|---|---|---|
| from which flaking has | | | | | | Greater |
| occured. (Example for) | | | | | | than |
| 6 parallel cuts) | None | [symbol] | [symbol] | [symbol] | [symbol] | 65% |
| Classification | 5 | 4 | 3 | 2 | 1 | 0 |

Results of commercial top coating (Type: AL97 ALESTA AP, Code: AF8005-4900522, from DuPont) on SP3-7%+A1289 and a commercial primer (DEVGUARD4160, DEVOE, ICI Paints) were reported. Classification 5, which is the best, was reported for both coatings. The adhesion test was also carried out for the same topcoat over SP3-7% also and yielded classification 5.

SP37+A1289 was top-coated by an aerospace topcoat (polyurethane DEFTHANE, Deft Chemical Coatings, Irvine, Calif.) both, a deionized water immersion and a dry adhesion test were carried out and the result was classification 5. Adhesion tests using a non-chromated topcoat (DESOTHENE HS, PRC DeSoto International Inc.) were also carried out and results were classification 5 again.

A 2-hour deionized (DI) boiling water adhesion test where the top-coated Panel was immersed in boiling water for 2 hours after scribing the topcoat using the cutting instruments and exposing the cut area. An adhesion tape test was carried out and the result was classification 5. An adhesion test of SP3-7%, SP3-7%+A1289 and SP3-7%+A1289−A1170 to the metal (hot-dip galvanized steel) was carried out to see if the absence of bis-amino silane had an effect on the adhesion. But the adhesion to metal result was classification 5 for all 3 types of coatings.

### Example 15

2000 Hour Salt Spray Test Results of Coating Compositions According to the Present Invention Top Coated with Polyester (Type: AL97 ALESTA AP, Code: AF8005-4900522, from DuPont)

The composition of the coatings was as follows.
Panel 1: SP3-7%+10% hydrolyzed A1289, primer and coating prepared as in Example 4,
Panel 2: DEVOE (commercial primer, DEVGUARD4160, DEVOE, from ICI Paints), the coating was obtained as in Example 1,
Panel 3: SP3-7%, primer and coating prepared as in Example 2,
Panel 4: SP3-7%+10% A1289, primer and coating prepared as in Example 1.

In addition, each of the four Panels was treated with a top coat of polyester (Type: AL97 ALESTA AP, Code: AF8005-4900522, from DuPont).

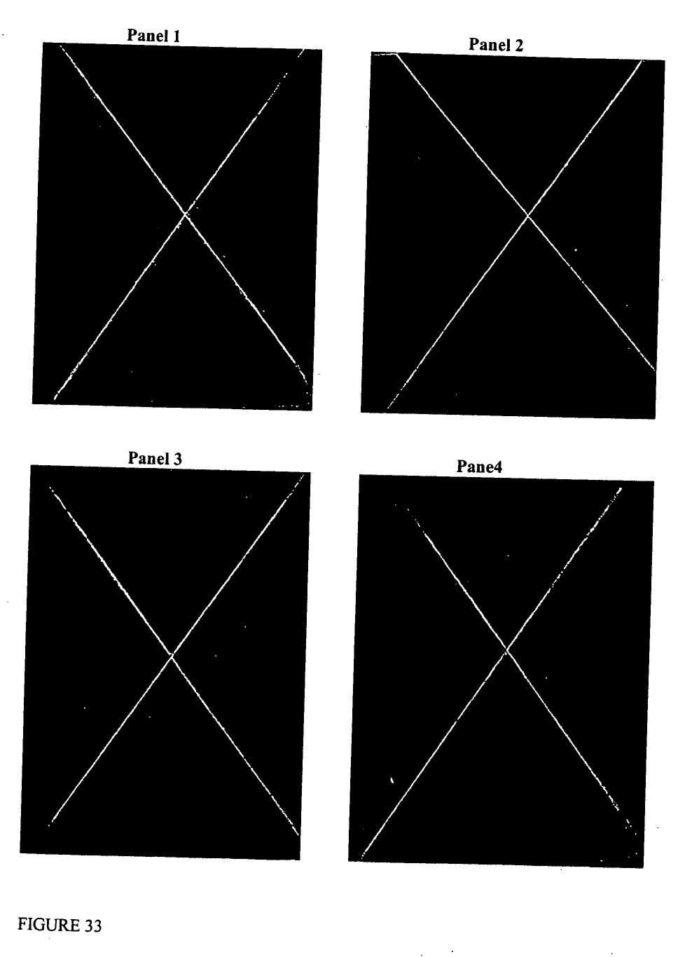

FIG. 33 shows 4 Panels which were subjected to a 2000 h salt spray test, based on the ASTM B-117 standard test. The Panels were kept at a 45° angle in a salt fog chamber and 5 wt. % NaCl salt solution was sprayed on the Panels continuously for 2000 hours. Thereafter, the Panels were scribed as described in Example 14.

Panels 1 and 2 showed equivalent performance. There are no corrosion products except on the scribes which have white rust of the galvanized metal. Panel 1 was coated with a primer containing a mixture of hydrolyzed bis-amino silane and hydrolyzed bis-sulfur silane. Panel 1 was equivalent to Panel 2 which contained a commercial primer commonly used in the industry. Therefore, hydrolyzed hydrophobic silanes are very effective in combination with hydrolyzed bis-amino silanes.

Panels 3 and 4 showed signs of red rust in the scribe. This is still a very good performance considering the primers of Panels 3 and 4 contain no additives that are present in a commercial primer, such as particles and pigments.

All patents and publications mentioned above are incorporated herein by reference.

Numerous modifications and variations on the present invention are possible in light of the above teachings. It is therefore to be understood that within the scope of the appended claims, the invention may be practiced otherwise than as specifically described herein.

1. A coating composition, comprising:
a resin;
a curing agent;
a catalyst; and
a hydrolyzed bis-amino silane.

2. The composition according to claim 1, further comprising a hydrophobic silane.

3. The composition according to claim 1, further comprising an at least partially hydrolyzed hydrophobic silane.

4. The composition according to claim 1, which is free of Cr (VI) ions.

5. The composition according to claim 1, comprising a member selected from the group consisting of polyurethanes, (meth)acrylates, polyesters, polysiloxanes, fluoropolymers, epoxy resins, and mixtures thereof.

6. The composition according to claim 1, comprising an epoxy resin.

7. The composition according to claim 1, comprising bisphenol-A epoxy resin.

8. The composition according to claim 1, comprising a resin having a molecular weight of from 200 to 600 g/mol.

9. The composition according to claim 1, comprising a resin having a viscosity of from about 1 to about 250 centipoise.

10. The composition according to claim 1, comprising a polyisocyanate as curing agent.

11. The composition according to claim 1, comprising an organic tin catalyst.

12. The composition according to claim 1, further comprising a solvent.

13. The composition according to claim 1, further comprising particles.

14. The composition according to claim 1, comprising titania.

15. The composition according to claim 1, comprising alumina.

16. A method of making a coating composition, comprising:
mixing a resin, a curing agent, a catalyst, and a hydrolyzed bis-amino silane.

17. The method according to claim 16, further comprising:
mixing a hydrophobic silane.

18. An article, coated with a cured composition of a resin, a curing agent, a catalyst, and a hydrolyzed bis-amino silane.

19. The article according to claim 18, wherein said composition further comprises a hydrophobic silane.

20. The composition according to claim 1, which is in cured form.

21. A corrosion protected structure, comprising:
a coating which comprises a resin, a curing agent, a catalyst, and a hydrolyzed bis-amino silane in cured form.

22. A method of coating a substrate, comprising:
coating a substrate with a composition comprising a resin, a curing agent, a catalyst, and a hydrolyzed bis-amino silane, to obtain a coating; and
curing said coating.
